(19) United States
(12) Patent Application Publication
(10) Pub. No.: US 2023/0075128 A1
(43) Pub. Date: Mar. 9, 2023

(54) COLUMN GENERATION METHODS AND SYSTEMS FOR ROUTING AND SCHEDULING IN ROBOTIC AND VEHICULAR APPLICATIONS

(71) Applicant: Next Generation Robotics, Inc., New York, NY (US)

(72) Inventors: Julian Yarkony, La Jolla, CA (US); David Pepper, New York, NY (US); Amelia Regan, Irvine, CA (US); Udayan Mandal, Irvine, CA (US)

(21) Appl. No.: 17/821,147

(22) Filed: Aug. 19, 2022

Related U.S. Application Data
(60) Provisional application No. 63/235,074, filed on Aug. 19, 2021.
(60) Provisional application No. 63/250,982, filed on Sep. 30, 2021.
(60) Provisional application No. 63/267,411, filed on Feb. 1, 2022.
(60) Provisional application No. 63/367,975, filed on Jul. 8, 2022.

(51) Int. Cl. G05D 1/00; G05B 19/4155; G05D 1/02

(52) U.S. Cl. CPC G05D 1/0088; G05B 19/4155; G05D 1/0217; G05D 1/0291; G05B 2219/50391

(57) ABSTRACT

Disclosed are devices, systems, and methods for routing and scheduling using column generation (CG)-based techniques. The described embodiments include dual optimal inequalities that incorporate detours (referred to as detour-DOI), graph generation (GG), principled graph management (PGM), and column generation with local area (LA) route relaxations. These CG-based techniques can be applied to a variety of logistical optimization problems that include, but are not limited to, the facility location problem, the capacitated vehicle routing problem (CVRP), the CVRP with time windows, multi-robot routing (both with and without time windows), the bus driver scheduling problem, the supply chain scheduling problem, the shift/workforce scheduling problem, and the grocery picking for micro-fulfillment problem.

### CROSS-REFERENCE TO RELATED APPLICATION

This present document claims priority to and benefits of U.S. Provisional Application 63/235,074 filed on Aug. 19, 2021, U.S. Provisional Application 63/250,982 filed on Sep. 30, 2021, U.S. Provisional Application 63/267,411 filed on Feb. 1, 2022, and U.S. Provisional Application 63/367,975 filed on Jul. 8, 2022. The entire contents of the aforementioned patent applications are incorporated by reference as part of the disclosure of this patent document.

### TECHNICAL FIELD

The present document generally relates to robotic and vehicular systems, and more specifically, to routing and scheduling in these systems using column generation (CG)-based optimization methods.

### BACKGROUND

Linear programming (LP, also called linear optimization) is a method to achieve the best outcome (such as maximum profit or lowest cost) in a mathematical model whose requirements are represented by linear relationships. Linear programming can be applied to various fields of study and various industries. Industries that use linear programming models include transportation, energy, telecommunications, and manufacturing. It has proven useful in modeling diverse types of problems in planning, routing, scheduling, assignment, and design.

### SUMMARY

In various applications, associated linear programs may be too large to consider all the variables explicitly. However, it is often the case that most of the variables will be non-basic and assume a value of zero in the optimal solution. Because of this, only a subset of variables need to be considered in theory when solving the problem. Column generation leverages this idea to generate only the variables which have the potential to improve the objective function that is, to find variables with negative reduced cost (assuming without loss of generality that the problem is a minimization problem).

Embodiments of the disclosed technology improve the efficiency of column generation (CG) methods, which can be applied to solve existing problems in industrial, military, and humanitarian logistics, and emerging sub-problems including rapid grocery delivery, the routing of robots in warehouses, and routing autonomous vehicles on street networks. In some examples, this may be achieved using CG-based optimization methods that include, but are not limited to, dual optimal inequalities that incorporate detours (referred to as detour-DOI), graph generation (GG), principled graph management (PGM), and local area (LA)-routes.

Each of the optimization methods enumerated above can be applied to a variety of logistical optimization problems that include, but are not limited to, the facility location problem, the capacitated vehicle routing problem (CVRP), the CVRP with time windows, multi-robot routing (both with and without time windows), the bus driver scheduling problem, the supply chain scheduling problem, the shift/workforce scheduling problem, and the grocery picking for micro-fulfillment problem, as described in this document.

In an example aspect, a method for routing a vehicle includes receiving information associated with the starting depot location, the ending depot location, and the items associated with the plurality of customers, wherein the information for each of the items comprises an item location and an integer demand indicating a size of the item, generating, based on the starting depot location, the ending depot location, the integer demand and the item location of each of the items, and a capacity of the vehicle, a vehicle routing problem, wherein a solution to the vehicle routing problem minimizes a distance of the route, wherein the route (a) starts at the starting depot location, (b) ends at the ending depot location, (c) visits each item location no more than once, and (d) services a capacity that does not exceed the capacity of the vehicle to carry items, splitting the vehicle routing problem into a master problem and a subproblem, wherein the master problem and the subproblem comprise constraints associated with the vehicle routing problem, computing, for the subproblem, a plurality of costs associated with distances between one or more item locations such that each of the distances is less than a first threshold, iteratively solving, using a column generation method with a local area route relaxation and based on the plurality of costs, the master problem and the subproblem to generate the solution comprising an optimized route that minimize the distance of the route, and transmitting, to the vehicle, the optimized route, wherein the column generation method comprises adding a column to the master problem as part of solving the subproblem, wherein the column corresponds to a particular route with a topological ordering of items serviced by a particular vehicle on the particular route, wherein the local area route relaxation comprises an ng-route relaxation, wherein the ng-route relaxation specifies that a first item location is followed by a second item location such that a distance between the first item location and the second item location is greater than a second threshold, wherein the local area route relaxation specifies that the distance between the first item location and the second item location is greater than a third threshold, and wherein the first threshold, second threshold and third threshold are positive numbers.

In another example aspect, a method for routing a vehicle includes receiving a depot location and a plurality of items, wherein each of the plurality of items is associated with an item location and an integer demand, and wherein each of the plurality of vehicles has a common capacity, generating, based on the depot location, the integer demand and the item location of each of the plurality of items, and the plurality of vehicles, a vehicle routing problem, wherein a solution to the vehicle routing problem minimizes a sum of a distance of each route of a plurality of routes, wherein each route of a plurality of routes for each of the plurality of vehicles (a) starts and ends at the depot location, (b) visits an item location no more than once, and (c) services a capacity that does not exceed the common capacity, splitting the vehicle routing problem into a master problem and a subproblem, wherein the master problem and the subproblem comprise constraints associated with the vehicle routing problem, iteratively solving, using a column generation method, the master problem and the subproblem to generate the solution comprising a plurality of optimized routes that minimize the sum of the distance of each route of the plurality of routes, and transmitting, to each of the plurality of vehicles, a corresponding optimized route of the plurality of optimized routes, wherein at least one optimized route of the plurality of optimized routes comprises a detour consisting of [i] a first segment from a first item location associated with a first item of the plurality of items to a second item location associated with a second item of the plurality of items and [ii] a second segment from the second item location to the first item location.

In yet another example aspect, a method for routing a vehicle includes receiving information associated with the depot location and the items, wherein the information for each of the items comprises an item location and an integer demand indicating a size of the item, generating, based on the depot location, the integer demand and the item location of each of the items, and the plurality of vehicles, a vehicle routing problem, wherein a solution to the vehicle routing problem minimizes a sum of a distance of each route of a plurality of routes, wherein each route of a plurality of routes for each of the plurality of vehicles (a) starts and ends at the depot location, (b) visits an item location no more than once, and (c) services a capacity that does not exceed each vehicle's capacity to carry items, splitting the vehicle routing problem into a master problem and a subproblem, wherein the master problem and the subproblem comprise constraints associated with the vehicle routing problem, iteratively solving, using a graph generation method, the master problem and the subproblem to generate the solution comprising a plurality of optimized routes that minimize the sum of the distance of each route of the plurality of routes, and transmitting, to each of the plurality of vehicles, a corresponding optimized route of the plurality of optimized routes, and wherein the graph generation method comprises a column generation method, wherein the column generation method comprises adding a column to the master problem as part of solving the subproblem, wherein the column corresponds to a particular route with a topological ordering of items serviced by a particular vehicle on the particular route, wherein the graph generation method further comprises adding a family of the column to the master problem, and wherein the family of the column corresponds to one or more routes that maintain the topological ordering of the items serviced by the particular route and do not exceed the capacity of the particular vehicle.

In yet another example aspect, a method for routing a vehicle includes receiving information associated with the depot location and the items, wherein the information for each of the items comprises an item location and an integer demand indicating a size of the item, generating, based on the depot location, the integer demand and the item location of each of the items, and the plurality of vehicles, a vehicle routing problem, wherein a solution to the vehicle routing problem minimizes a sum of a distance of each route of a plurality of routes, wherein each route of a plurality of routes for each of the plurality of vehicles (a) starts and ends at the depot location, (b) visits an item location no more than once, and (c) services a capacity that does not exceed each vehicle's capacity to carry items, splitting the vehicle routing problem into a master problem and a subproblem, wherein the master problem and the subproblem comprise constraints associated with the vehicle routing problem, iteratively solving, using a principled graph management method, the master problem and the subproblem to generate the solution comprising a plurality of optimized routes that minimize the sum of the distance of each route of the plurality of routes, and transmitting, to each of the plurality of vehicles, a corresponding optimized route of the plurality of optimized routes, wherein the principled graph management method comprises a graph generation method, wherein the graph generation method comprises a column generation method, wherein the column generation method comprises adding a column to the master problem as part of solving the subproblem, wherein the column corresponds to a particular route with a topological ordering of items serviced by a particular vehicle on the particular route, wherein the graph generation method further comprises adding a family of the column to the master problem, wherein the family of the column corresponds to one or more routes that maintain the topological ordering of the items serviced by the particular route and do not exceed the capacity of the particular vehicle, wherein the principled graph management method further comprises adding one or more edges, associated with the family of the column, to the master problem to generate an alternative master problem, and wherein every solution of the alternative master problem is a solution to the master problem.

In yet another example aspect, a distributed computing system that implements the above-described methods is disclosed.

In yet another example aspect, the methods may be embodied as processor-executable code and may be stored on a computer-readable program medium.

These, and other, features are described in this document.

### BRIEF DESCRIPTION OF THE DRAWINGS

Drawings described herein are used to provide a further understanding and constitute a part of this application. Example embodiments and illustrations thereof are used to explain the technology rather than limiting its scope.

FIGS. 1A and 1B show different example representations of implementing a column generation (CG) algorithm.

FIG. 2 shows an example of a 4-neighbor grid used for computational efficiency in the multi-robot routing (MRR) problem.

FIGS. 3A and 3B show examples of performance improvement of detour-DOI as compared to existing implementations.

FIG. 4 shows an example algorithm for graph generation (GG).

FIG. 5 shows an example algorithm for principled graph management (PGM).

FIGS. 6A and 6B show examples of performance improvement of PGM as compared to existing implementations.

FIG. 7 shows an example of a warehouse with robots that are routed or scheduled according to embodiments of the presently disclosed technology.

FIG. 8 is a block diagram representation of a portion of an apparatus that can be configured to implement some embodiments of the presently disclosed technology.

FIG. 9 show a flowchart of an example method according to embodiments of the presently disclosed technology.

### DETAILED DESCRIPTION

To make the purposes, technical solutions and advantages of this disclosure more apparent, various embodiments are described in detail below with reference to the drawings. Unless otherwise noted, embodiments and features in embodiments of the present document may be combined with each other.

Section headings are used in the present document to improve readability of the description and do not in any way limit the discussion, implementations, or embodiments to the respective sections only. Furthermore, embodiments being specifically described in the context of vehicles or robots is for the sake of clarity of exposition. The techniques disclosed in the present document are not limited to the vehicular systems, transportation systems, and/or robotic systems described for a particular embodiment, and may be used in systems that employ robots or vehicles with varying levels of automation (or autonomy).

### 1 Introduction

Column generation is a widely used tool in computational optimization as a way to solve huge mixed integer problems. One of the main advantages of column generation is that not all possible solutions of the problem need to be enumerated. Instead, the problem being solved is split into two problems: the master problem and the sub-problem. The master problem is the original column-wise formulation of the problem with only a subset of variables being considered (and is also referred to as the restricted master problem (RMP)). The sub-problem is a new problem created to identify a new promising variable. The objective function of the sub-problem is the reduced cost of the new variable with respect to the current dual variables, and the constraints require that the variable obeys the naturally occurring constraints.

When the master problem is solved, dual prices can be obtained for each of the constraints in the master problem. This information is then utilized in the objective function of the subproblem. The subproblem is solved. If the objective value of the subproblem solution is negative, a variable with negative reduced cost has been identified. This variable is then added to the master problem, and the master problem is re-solved. Re-solving the master problem will generate a new set of dual values, and the process is repeated until no negative reduced cost variables are identified. The subproblem returns a solution with non-negative reduced cost, it can be concluded that the solution to the master problem is optimal.

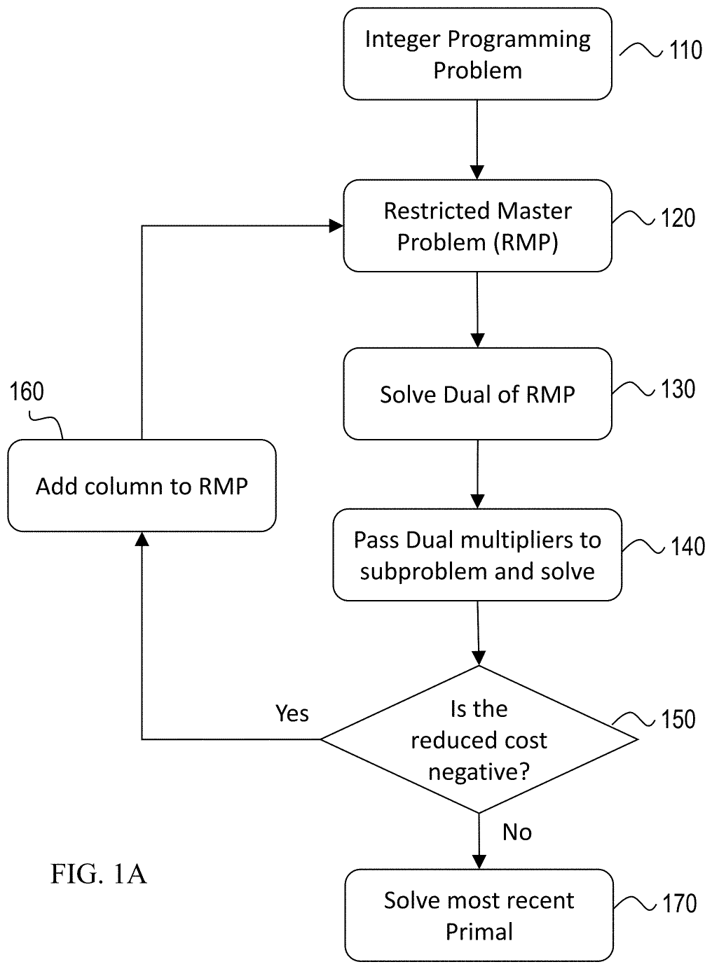

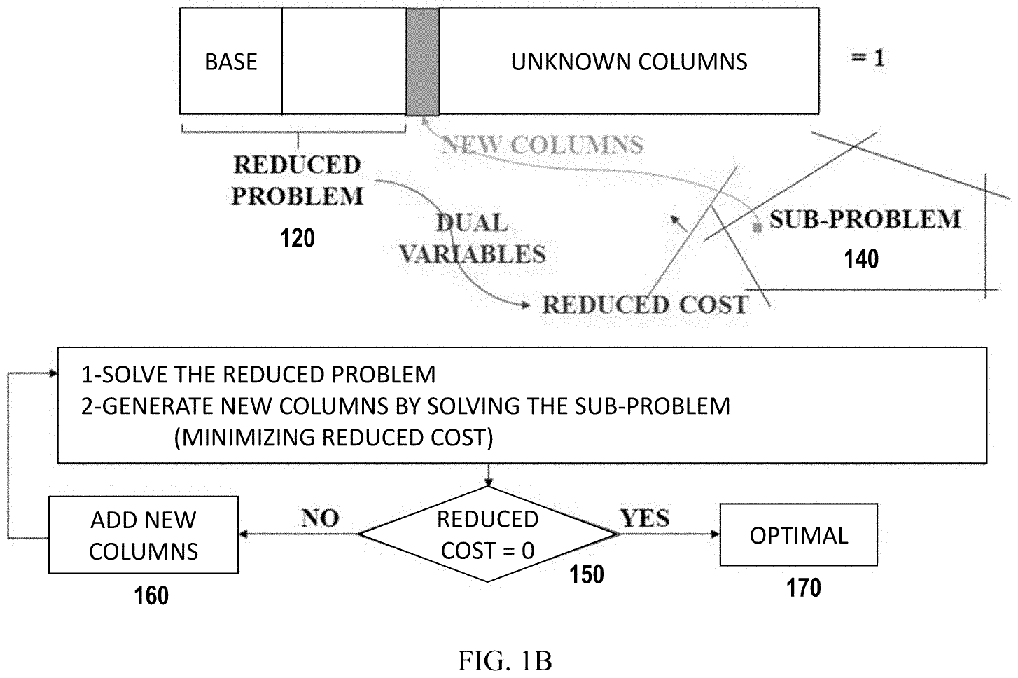

FIGS. 1A and 1B show different representations of an example column generation algorithm. As shown therein, the integer program is first formulated (step 110) and used to generate the restricted master problem (RMP) (step 120). The dual of the RMP is solved (step 130), and the dual multipliers are passed to the subproblem to be solved (step 140). The algorithm checks whether any of the reduced costs are negative (step 150); if yes, the column is added to the RMP (step 160), and if not, the most recent primal solution is solved (step 170).

In other words, during the column generation process, the dual variables (i.e., multipliers) are used to price out the non-basic variables (i.e., columns) by considering their reduced costs. The dual variables ensure that the reduced cost for every variable in the basis is zero. If any reduced cost is of the wrong sign in the master problem, the process will introduce the corresponding non-basic variable into the basis in place of one of the current basic variables, and recompute the simplex multipliers (i.e., dual variables).

### 1.1 Overview of Column Generation

The basic column generation (CG) problem is discussed in this section in the context of the broad class of set cover problems. Herein, for the facility location problem (discussed in section 1.3), N is used to denote the set of items to be covered, which is indexed by u; F is used to denote the set of facilities, which is index by f. The set of feasible pairs between a subset of N and a single member f is denoted using l, and which is described using aᵤₗ∈{0,1} and b_{fl}∈{0,1}. Here, aᵤₗ=1 if and only if (IFF) l includes item u and otherwise aᵤₗ=0. Similarly, b_{fl}=1 IFF/uses facility f and otherwise b_{fl}=0. Each l∈Ω is associated with a cost cₗ. Set cover is framed as the following set cover integer linear program (ILP), which enforces that each facility is used no more than once. Here, θₗ∈{0,1} is a binary variable used to describe the solution to set cover, and θₗ=1 IFF l is included in the solution and otherwise is zero.

$${min}_{{θ}_{l} ∈ \{ 0 , 1 \}} {\sum }_{l ∈ Ω} {c}_{l} {θ}_{l} \qquad ( 1.1 \text{.1} a )$$

$$\begin{matrix}{\sum }_{l ∈ Ω} {a}_{ul} {θ}_{l} \geq 1 & ∀ u ∈ N\end{matrix} \qquad ( 1.1 \text{.1} b )$$

$$\begin{matrix}{\sum }_{l ∈ Ω} \text{?} {θ}_{l} \geq 1 & ∀ \text{?} ∈ F\end{matrix} \qquad ( 1.1 \text{.1} c )$$

$$\text{?} \text{indicates text missing or illegible when filed}$$

For the above equations, the total cost of columns in Ω that were selected is minimized in (1.1.1a). (1.1.1b) enforces that each item is included in at least one column. In most applications (1.1.1b) is tight for all u∈N in any optimal solution. (1.1.1c) enforces that no facility is used more than once. In some embodiments, the total number of columns selected not exceeding a particular value can be enforced, e.g., by offsetting cₗ by a constant for all l to encourage (or discourage) the use of more columns. The above formulation includes the single source capacitated facility location problem (SSCFLP) and the vehicle routing problem (VRP).

Solving (1.1.1) is NP-hard; however efficient exact or approximate algorithms can be built using the column generation (CG) framework. CG solves the LP relaxation of (1.1.1), which is well approximated in many applications.

In CG, a sufficient subset of f, denoted SR, is generated to provably solve optimization over all Ω. This is done by iteratively solving the LP over Ω_{R} and adding columns with negative reduced cost to the nascent set of columns Ω_{R}. CG terminates when no column in Ω_{R} has negative reduced cost. The primal and dual LP relaxations over Ω_{R}, with dual variables denoted in [ ] by their associated constraints, as shown below:

$$Primal Optimization : {min}_{θ \geq 0} {\sum }_{l ∈ {Ω}_{R}} {c}_{l} {θ}_{l} \qquad ( 1.1 \text{.2} a )$$

$${\sum }_{l ∈ {Ω}_{R}} {a}_{ul} {θ}_{l} \geq \begin{matrix}1 & ∀ u ∈ N & [ {π}_{u} ]\end{matrix} \qquad ( 1.1 \text{.2} b )$$

$${\sum }_{l ∈ {Ω}_{R}} {b}_{fl} {θ}_{l} \leq \begin{matrix}1 & ∀ f ∈ F & [ - {π}_{f} ]\end{matrix} \qquad ( 1.1 \text{.2} c )$$

$$Dual Optimization : {max}_{π \geq 0} {\sum }_{u ∈ N} {π}_{u} - {\sum }_{f ∈ F} {π}_{f} \qquad ( 1.1 \text{.3} a )$$

$${c}_{l} + {\sum }_{f ∈ F} {b}_{fl} {π}_{f} - {\sum }_{l ∈ Ω} {a}_{ul} {π}_{u} \geq \begin{matrix}0 & ∀ l ∈ {Ω}_{R} , [ {θ}_{l} ]\end{matrix} \qquad ( 1.1 \text{.3} b )$$

CG optimization is initialized with columns in Ω_{R} that describe a feasible solution to (1.1.2). This is followed by CG iterating between the following two steps until no column has a negative reduced cost.

Step 1. Solve (1.1.2) providing a primal and a dual solution

Step 2. Find the lowest reduced cost column associated with each facility f∈F, and add the negative reduced cost columns identified to Ω_{R}. This step is referring to as pricing.

CG terminates when pricing fails to identify a negative reduced cost column. The corresponding primal solution θ is provably optimal for optimization over Ω at the termination of CG. In an example, pricing is written below for a given fixed facility f, with Ω_{f} used to denote the subset of columns associated with f and c̅ₗ used to denote the reduced cost of column l.

$$\text{?} {\overline{c}}_{l} \qquad ( 1.1 \text{.4} a )$$

$${\overline{c}}_{l} = {c}_{l} + {π}_{f} - {\sum }_{u ∈ N} {a}_{ul} {π}_{u} \qquad ( 1.1 \text{.4} b )$$

$$\text{?} \text{indicates text missing or illegible when filed}$$

Solving pricing is typically a combinatorial optimization problem, and is typically problem-domain specific. Most commonly it is solved as a dynamic program or resource constrained shortest path problem, although in some cases, it can be a small-scale ILP. The solution at termination of optimization may still be fractional. Multiple mechanisms can be used to tackle this issue while achieving exact optimization. The set cover LP relaxation can be further tightened in a cutting plane manner by valid inequalities such as subset-row inequalities. The use of such valid inequalities permits optimization with CG. CG can be built into an exact branch-bound search procedure using branch-price.

### 1.2 Examples of Lagrangian Relaxation

In some embodiments, the Lagrangian function is smooth and concave, and has a value identical to that of the master problem (MP) at the optimizing dual solution for the MP. The value of the Lagrangian function evaluated at given dual solution is referred to as the Lagrangian bound. At any given point in CG optimization a lower bound on the optimal solution can be generated, which is referred to as the Lagrangian bound. The Lagrangian bound can be used to provide as stopping criteria for CG (e.g., for early termination). In an example, when the difference between the objective of the RMP solution and the Lagrangian bound is sufficiently small (according to a user-defined criteria), the CG optimization may be terminated.

Given a dual solution π, the Lagrangian bound at the dual solution is denoted l_{π} and can be defined as:

$$MP \geq {ℓ}_{π} = {\sum }_{u ∈ N} {π}_{u} - {\sum }_{f ∈ F} {π}_{f} + {\sum }_{f ∈ F} min ( 0 , \text{?} {\overline{c}}_{l} ) \qquad ( 1.2 \text{.5} a )$$

$$\text{?} \text{indicates text missing or illegible when filed}$$

It is noted that pricing provides min_{l∈Ω}_{_{f}}c̅ₗ at each iteration of CG, and thus evaluating the Lagrangian bound incurs no additional computational difficulty. Furthermore, any non-negative solution π can be projected to one that is a feasible solution to the dual master problem ((1.1.3) with Ω_{R}←Ω) with an objective identical to the Lagrangian bound in (1.2.5a) by setting π_{f}←π_{f}+min(0,min_{l∈Ω}_{_{f}} c̅ₗ).

### 2 Example Applications for CG-Based Optimization Methods

In some embodiments, the disclosed technology, e.g., detour-DOI, graph generation (GG), principled graph management (PGM), and local area (LA)-routes, can be implemented in various applications or implementations that include, but are not limited to, the frameworks discussed below. One or more of these example applications can be implemented in the context of vehicles, transportation systems, and/or robots, with varying degrees of autonomy.

For example, different types of autonomous vehicles have been classified into different levels of automation under the Society of Automotive Engineers' (SAE) J3016 standard, which ranges from Level 0 in which the vehicle has no automation to Level 5 (L5) in which the vehicle has full autonomy. In an example, SAE Level 4 (L4) is characterized by the vehicle operating without human input or oversight but only under select conditions defined by factors such as road type or geographic area. Thus, in the example of the capacitated vehicle routing problem, the disclosed technology advantageously provides optimized routes for the vehicles, which may be operating in a Level 0 automation mode (completely controlled by the human driver) or in a Level 5 automation mode (with no human intervention).

Similarly, the autonomy of robots are classified may be classified as being Level 0 (full manual teleoperation), Level 1 (robot within line of sight, hands off), Level 2 (operator on site or nearby, eyes off), Level 3 (one operator oversees many robots, mind off), Level 4 (supervisor not on site, monitoring off), or Level 5 (robots adapt and improve execution, development off). Alternatively, the autonomy of robots may be classified using the 10-level classification index developed by 451 Research, wherein Level 0 includes the original industrial robots, Level 6 robots are equivalent to SAE level 5 autonomous vehicles, and Level 9 represents robots that are autonomous, highly mobile, and versatile that work in cooperation with others.

### 2.1 the Capacitated Vehicle Routing Problem (CVRP)

In some embodiments, the described CG-based optimization solutions can be applied in the context of the capacitated vehicle routing problem (CVRP). The CVRP is defined by a set of items and a starting/ending depot embedded in a metric space. Each item is associated with an integer demand (e.g., indicating a size of the item or the cost of the item) and each of the vehicles have a capacity. In an example, the vehicles may have a common capacity. In another example, the capacities of each vehicle may be distinct. Solving the CVRP corresponds to partitioning the items into ordered lists of items called routes, each of which is serviced by a unique vehicle so as to minimize the total distance traveled. The constraints applied ensure that no vehicle services more demand than it has capacity, and that the number of vehicles used is bounded.

In a formal description of the CVRP, N is used to denote the set of items that is indexed by u. Define N⁺ to be N augmented with the starting depot and the ending depot, which are denoted −1 and −2, respectively (and are typically the same place). Items and depots are embedded on a metric space, and hence distances between them satisfy the triangle inequality. Use cᵤᵥ to denote the distance between any pair of u, v each of which lies in N⁺. Each item is associated with an integer demand dᵤ, which lies in the set of unique demands [symbol] , and where D₀ is the capacity of a vehicle. Thus, a route is feasible if it satisfies the following:
The route starts and ends at the starting/ending depots, respectively;
The route visits an item no more than once; and
The route services total demand that does not exceed D₀.

The set of routes is denoted Ω and index by l. A mapping of items to routes uses aᵤₗ∈{0,1}, where aᵤₗ=1 if and only if route l contains item u for any u∈N. For shorthand, the notation Nₗ{∀u∈N s.t. aᵤₗ=1} means that Nₗ is the set of items serviced by l. For any u, v pair wherein each lies in N⁺, set aᵤᵥₗ=1 if and only if v follows u immediately in route l and otherwise set aᵤᵥₗ=0. The cost of a route is denoted cₗ and is defined as the total distance traveled, which is determined as:

$${c}_{l} = {\sum }_{{u ∈ {N}^{+}}_{v ∈ {N}^{+}}} {c}_{uv} \begin{matrix}{a}_{uvl} & ∀ l ∈ Ω\end{matrix} \qquad ( 2.1 \text{.1} )$$

The constraint that a route services no more demand than D₀ is determined as shown in (2.1.2) using dᵤ to denote the demand of item u.

$${\sum }_{u ∈ N} {d}_{u} {a}_{ul} \leq \begin{matrix}{D}_{0} & ∀ l ∈ Ω\end{matrix} \qquad ( 2.1 \text{.2} )$$

A set of routes provides a feasible solution to CVRP if it services every item at least once and uses no more than K routes, where K denotes the number of vehicles available. A solution to the CVRP can be described using decision variables θₗ∈{0,1} where θₗ=1 indicates that route l is selected and otherwise θₗ=0. The selection of the optimal solution is determined as:

$${min}_{θ ∈ \{ 0 , 1 \}} {\sum }_{l ∈ Ω} {c}_{l} {θ}_{l} \qquad ( 2.1 \text{.3} a )$$

$${\sum }_{l ∈ Ω} {a}_{ul} {θ}_{l} \geq \begin{matrix}1 & ∀ u ∈ N\end{matrix} \qquad ( 2.1 \text{.3} b )$$

$${\sum }_{l ∈ Ω} {θ}_{l} \leq K \qquad ( 2.1 \text{.3} c )$$

Herein, (2.1.3a) minimizes the total cost of the routes selected, and (2.1.3b) ensures every item is covered at least once. In any optimal solution, each item is covered exactly once since cₗ increases as Nₗ grows. (2.1.3c) enforces no more than K routes are used.

Equations (2.1.3) can be solved via solving the linear programming (LP) relaxation, which is referred to as the master problem (MP). This LP relaxation is very tight in practice and can be tightened using branch-cut-price. The MP can be determined as shown below, with dual variables written in brackets ([ ]) after the equations.

$${min}_{θ \geq 0} {\sum }_{l ∈ Ω} {c}_{l} {θ}_{l} \qquad ( 2.1 \text{.4} a )$$

$$\begin{matrix}{\sum }_{l ∈ Ω} {a}_{ul} {θ}_{l} \geq 1 & ∀ u ∈ N & [ {π}_{u} ]\end{matrix} \qquad ( 2.1 \text{.4} b )$$

$${\sum }_{l ∈ Ω} {θ}_{l} \leq \begin{matrix}K & [ - {π}_{0} ]\end{matrix} \qquad ( 2.1 \text{.4} c )$$

The dual form of (2.1.4) can be determined as:

$${max}_{π \geq 0} - K {π}_{0} + {\sum }_{u ∈ N} {π}_{u} \qquad ( 2.1 \text{.5} a )$$

$$\begin{matrix}{c}_{l} + {π}_{0} - {\sum }_{u ∈ N} {a}_{ul} {π}_{u} \geq 0 & ∀ l ∈ Ω\end{matrix} \qquad ( 2.1 \text{.5} b )$$

Since the set of routes (Ω) grows exponentially in the number of items, (2.1.4) cannot be trivially solved, and column generation (CG) is used to solve (2.1.4). CG constructs a sufficient subset of Ω, denoted Ωᵣ, such that solving (2.1.4) over Ωᵣ, provides an optimal solution to (2.1.4) over Ω. To construct Ωᵣ, iterate between (1) solving (2.1.4) over Ωᵣ, which is referred to as the restricted master problem (RMP) and (2) identifying variables with negative reduced cost, which are then added to Ωᵣ. Typically, the lowest reduced cost column is generated. The selection of this column is written as the optimization below using Ci to denote the reduced cost of column l.

$${min}_{l ∈ Ω} {\overline{c}}_{l} \qquad ( 2.1 \text{.6} a )$$

$${\overline{c}}_{l} = {c}_{l} + {π}_{0} - {\sum }_{u ∈ N} {a}_{ul} {π}_{u} \qquad ( 2.1 \text{.6} b )$$

The operation in (2.1.6) is referred to as pricing. One or more negative reduced cost columns are generated during pricing. CG terminates when pricing finds no column with negative reduced cost. This certifies that CG has produced the optimal solution to (2.1.4). Pricing is written as an integer linear program (ILP), and may be solved with a resource constrained shortest path solver. CG is terminated when no l in Ω has negative reduced cost. In some embodiments, CG initializes Ωᵣ, with a heuristically generated feasible integer solution or using artificial variables that have prohibitively high cost but ensure a feasible solution.

In some embodiments, the CVRP is defined such that the starting depot is the same as the ending depot. In this scenario, a solution to the CVRP corresponds to a solution to the vehicle routing problem that minimizes a sum of a distance of each route of a plurality of routes, wherein each route of a plurality of routes for each of the plurality of vehicles (a) starts and ends at the depot location, (b) visits an item location no more than once, and (c) services a capacity that does not exceed each vehicle's capacity to carry items.

In some embodiments, the CVRP is defined such that the starting depot is different from the ending depot. In this scenario, a solution to the CVRP corresponds to a solution to the vehicle routing problem that minimizes a distance of the route, wherein the route (a) starts at the starting depot location, (b) ends at the ending depot location, (c) visits each item location no more than once, and (d) services a capacity that does not exceed the capacity of the vehicle to carry items.

In the embodiments described above, the route represents an optimal solution to the CVRP and, therefore, does not visit an item location more than once. However, a sub-optimal solution to the CVRP might visit an item location more than once, but this sub-optimal solution will not be the (final) route that is selected by the CG-based optimization methods disclosed in the present document.

### 2.2 the Multi-Robot Routing (MRR) Problem

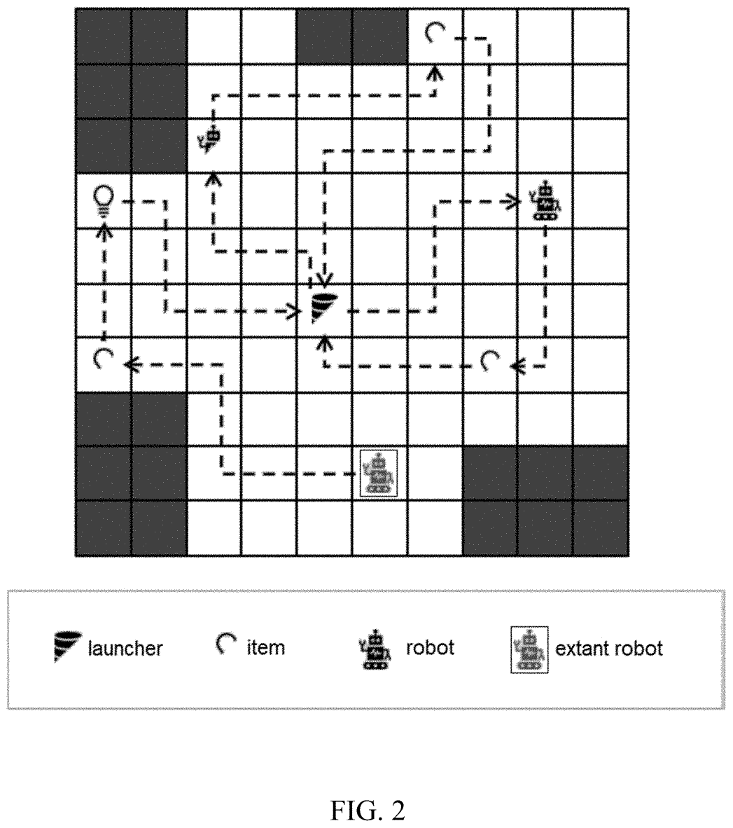

In some embodiments, the described CG-based optimization solutions can be applied in the context of the multi-robot routing (MRR) problem. In the MRR problem, each of a fleet of mobile warehouse robots that enter the warehouse floor from a single location, called the launcher, pick up one or multiple items inside the warehouse, and deliver them to the launcher. Each item has a positive-valued reward, and each robot has a capacity and is allowed to perform multiple trips. In some embodiments, one or more robots, called extant robots, are allowed to begin at other locations different from the launcher. For computational efficiency, the continuous space-time positions that robots occupy are approximated by treating the warehouse as a 4-neighbor grid and treating time as a set of discrete time points (as shown in FIG. 2).

Each position on the grid is referred to as a cell. Cells are generally traversable, but some cells are obstructed and cannot be traversed. Through each time point, robots are capable of remaining stationary or moving to an adjacent unobstructed cell in the four main compass directions, which we connect through edges. Robots are required to avoid collisions by not occupying the same cell at any time point and not traversing the same edge in opposite directions between any successive time points. Every item is located at a unique cell. Robots incur a time-based cost (negative valued) while deployed on the grid, and a distance-based cost (negative valued) for moving on the grid, but obtain a reward for servicing an item (positive valued).

To service an item, a robot must travel to the specific cell where the item is located during the item's associated serviceable time window and pick it up for delivery to the launcher. Servicing an item consumes a portion of the robot's capacity, which is refreshed once it travels back to the launcher. The complete path a specific robot takes, which necessarily ends at the launcher, is called a route.

In a formal description of the MRR problem, [symbol] is used to denote the set of feasible routes, which is indexed by g, and is typically too large to be enumerated. Γ_{g}∈ [symbol] is used to denote the net profit of robot route g, and γ_{g}∈{0,1} is used to describe a solution that includes g if and only if γ_{g}=1. The sets of items, times, and extant robots are described as [symbol] , [symbol] and [symbol] , respectively, and are indexed by d, t, and r, respectively. The time-extended graph is denoted ( [symbol] ,ε), wherein every p∈ [symbol] represents a space-time position, which is determined by a location (i.e., an unobstructed cell on the warehouse grid) and a time t∈ [symbol] . Two space-time positions pᵢ, pⱼ∈ [symbol] are connected by a (directed) space time edge e=(pᵢ, pⱼ)∈ε if and only if the locations of pᵢ and pⱼ are the same cell of adjacent cells and the time of pⱼ is the time of pᵢ+1.

Continuing with the formal description, ε̅ is defined as the set of pairs of conflicting edges that are indexed as ē=(eᵢ, eⱼ). A pair of space-time edges (eᵢ, eⱼ) lies in \hat{ε} if and only if the transitions occur at the same point in time and between the same two points in space butin opposite direction. The set can be used to prevent collisions. The routes are described using G_{ig} ∈{0,1} for i∈ [symbol] ={ [symbol] ∪ [symbol] ∪ [symbol] ∪ε [symbol] }. Furthermore,
set G_{dg}=1 if and only if route g services item d;
set G_{tg}=1 if and only if route g is active (moving or waiting) at time t;
set G_{pg}=1 if and only if route g includes space-time position p;
set G_{rg}=1 if and only if route g is associated with extant robot r; and
set G_{eg}=1 if and only if route g uses space-time edge e.

Furthermore, N is used to denote the total number of robots available in the fleet.

Thus, the MRR problem can be written as an ILP as follows:

$${max}_{{γ}_{g} ∈ \{ 0 , 1 \} {∀}_{g} ∈ ℊ} \text{?} {Γ}_{g} {γ}_{g} \qquad ( 2.2 \text{.1} )$$

$$\begin{matrix}\text{?} {G}_{dg} {γ}_{g} \leq 1 & ∀ d ∈ 𝒟\end{matrix} \qquad ( 2.2 \text{.2} )$$

$$\begin{matrix}\text{?} {G}_{tg} {γ}_{g} \leq N & ∀ t ∈ 𝒯\end{matrix} \qquad ( 2.2 \text{.3} )$$

$$\begin{matrix}\text{?} {G}_{rg} {γ}_{g} = 1 & ∀ r ∈ ℛ\end{matrix} \qquad ( 2.2 \text{.4} )$$

$$\begin{matrix}\text{?} {G}_{pg} {γ}_{g} \leq 1 & ∀ p ∈ 𝒫\end{matrix} \qquad ( 2.2 \text{.5} )$$

$$\begin{matrix}\text{?} ( \text{?} + \text{?} ) {γ}_{g} \leq 1 & ∀ \text{?} ∈ \text{?}\end{matrix} \qquad ( 2.2 \text{.6} )$$

$$\text{?} \text{indicates text missing or illegible when filed}$$

In (2.2.1), the net profit of the MRR solution (that includes the rewards collected minus the operational costs of the robot) is maximized. (2.2.2) ensures that no item is serviced more than once, (2.2.3) ensures that no more than the available number of robots N are used at any given time, (2.2.4) ensures that each extant robot is associated with exactly one route, (2.2.5) ensures that no more than one robot can occupy a given space-time position, and (2.2.6) ensures that no more than one robot can use a space-time edge in any given conflicting set, thereby preventing collisions and also preventing pairs or robots from swapping spatial positions at a given point in time.

For the robot routes considered in this example, each item d∈ [symbol] uses c_{d} units of capacity of a robot, with the capacity of the robot being represented as c₀. An active (extant) robot r∈ [symbol] is associated with an initial space-time position p₀ᵣ (at the initial time, e.g., time 1) and a remaining capacity cᵣ∈[0, c₀]. The cost associated with the robot route is defined based on (a) θ_{d}, which is the reward for servicing item d, (b) θ₁, θ₂ are the costs of being on the floor and moving respectively, which can account for both operational and depreciation costs. Thus, the net profit of robot route g is determined as:

$${Γ}_{g} = {\sum }_{d ∈ 𝒟} {θ}_{d} {G}_{d g} + {\sum }_{t ∈ 𝒯} {θ}_{1} {G}_{tg} + {\sum }_{e ∈ ℰ} {θ}_{2} {G}_{eg} \qquad ( 2.2 \text{.7} )$$

In some embodiments, a solution to the MRR problem corresponds to a solution to the robot routing problem that maximizes a sum of rewards associated with picking up each of a plurality of items, wherein each robot of a plurality of robots (a) starts and ends at the launcher location and (b) is associated with exactly one route of a plurality of routes, and (c) services a capacity that does not exceed each robot's capacity to carry items, wherein each of the plurality of items is serviced exactly once, wherein a number of the plurality of robots is less than or equal to a maximum number of robots, and wherein no more than one robot of the plurality of robots can occupy a given space-time location.

### 2.3 Incorporating Time Windows into the CVRP and MRR Problem

In some embodiments, the described CG-based optimization solutions can be applied in the context of the CVRP with time windows and the MRR problem with time windows. In an example, the CVRP with time windows imposes the additional constraint that each item can be serviced by a vehicle only within a specified time window, i.e., after a predetermined starting time and before a predetermined ending time. Similarly, the MRR problem with time windows imposes the additional constraint that every robot must return to the launcher item before a predetermined time limit. Alternatively, or additionally, the MRR problem with time windows imposes the additional constraint that each item may be picked up only within a specific time window. The remainder of the formulation for the CVRP and the MRR problem remains the same as described in sections 2.1 and 2.2, respectively.

In some embodiments, the CVRP with time windows is defined such that the starting depot is the same as the ending depot. In this scenario, a solution to the CVRP corresponds to a solution to the vehicle routing problem that minimizes a sum of a distance of each route of a plurality of routes, wherein each route of a plurality of routes for each of the plurality of vehicles (a) starts and ends at the depot location, (b) visits an item location no more than once and within a corresponding window start time and a corresponding window end time, and (c) services a capacity that does not exceed each vehicle's capacity to carry items.

In some embodiments, the CVRP is defined such that the starting depot is different from the ending depot. In this scenario, a solution to the CVRP with time windows corresponds to a solution to the vehicle routing problem that minimizes a distance of the route, wherein the route (a) starts at the starting depot location, (b) ends at the ending depot location, (c) visits each item location no more than once and within a corresponding window start time and a corresponding window end time, and (d) services a capacity that does not exceed the capacity of the vehicle to carry items.

In some embodiments, a solution to the MRR problem with time windows corresponds to a solution to the robot routing problem that maximizes a sum of rewards associated with picking up each of a plurality of items within a corresponding window start time and a corresponding window end time, wherein each robot of a plurality of robots (a) starts and ends at the launcher location and (b) is associated with exactly one route of a plurality of routes, and (c) services a capacity that does not exceed each robot's capacity to carry items, wherein each of the plurality of items is serviced exactly once, wherein a number of the plurality of robots is less than or equal to a maximum number of robots, and wherein no more than one robot of the plurality of robots can occupy a given space-time location.

### 2.4 the Facility Location Problem

In some embodiments, the described CG-based optimization solutions can be applied in the context of the single source capacitated facility location problem (SSCFLP). Herein, a set of customers N and a set of potential facilities F are provided such that F∩N=Ø. Each facility f∈F is associated with a fixed opening cost c_{f} and a capacity K_{f}. Each customer u∈N is associated with a demand dᵤ≥0. Each pair (f, u)∈F×N is associated with an assignment cost c_{fu}≥0. Without loss of generality, it is assumed that all parameters are integer-valued. The facility location problem requires selecting a subset of facilities to open and assigning every customer to exactly one open facility in such a way that the capacities of the selected facilities are respected, and a minimum total cost (fixed costs+assignment costs) is achieved.

The pricing subproblem is a 0-1 knapsack problem, and can be conditioned on facility f and written as.

$${min}_{{x}_{u} ∈ \{ 0 , 1 \} ∀ u ∈ N} {c}_{f} + {π}_{f} + {\sum }_{u ∈ N} {x}_{u} ( {c}_{fu} - {π}_{u} ) \qquad ( 2.4 \text{.6} a )$$

$${\sum }_{u ∈ N} {x}_{u} {d}_{u} \leq {K}_{f} \qquad ( 2.4 \text{.6} b )$$

Herein, xᵤ∈{0,1} denotes the decision variable for customer u, wherein xᵤ=1 IFF customer u is included.

In some embodiments, a solution to the facility location problem corresponds to a solution that minimizes a total cost of opening a subset of the plurality of facilities such that (a) each of plurality of customers is assigned to exactly one of the subset of the plurality of facilities and (b) the demand for a particular customer is less than the capacity of the assigned facility, and wherein the total cost comprises the opening cost for each of subset of the plurality of facilities and a cost associated with assigning the particular customer to the corresponding facility.

### 2.5 the Bus Driver Scheduling Problem

In some embodiments, the described CG-based optimization solutions can be applied in the context of the bus driver scheduling problem. Bus driver scheduling aims to find the minimum number of bus drivers needed to cover a published timetable of a bus company. When scheduling bus drivers, contractual working rules must be enforced.

Herein, u∈N denotes the set of duties which is a sequence of visits of a bus driver prior to a break, wherein each of the duties start and end at one of a set of break stations, and l∈Ω denotes the set of routes for the bus driver. A route consists of a sequence of duties where the start of a given duty is the same as the end of the previous duty. In an example, feasible routes may be governed by constraints as generated by a typical labor contract. The cost of a route is low level polynomial function of the duties in the route. For example, having longer sequences of duties without a break leads to higher cost.

In this formulation, cₗ denotes the cost of the route l and aᵤₗ=1 if route l services duty u. Furthermore, θₗ=1 is used to include route l in the solution, and K is used to denote the maximum number of bus drivers available. Thus, the optimization for the bus driver scheduling problem can be formulated as:

$${min}_{θ \geq 0} {\sum }_{l ∈ Ω} {c}_{l} {θ}_{l} \qquad ( 2.5 \text{.1} a )$$

$${\sum }_{l ∈ Ω} {a}_{ul} {θ}_{l} \geq 1 \qquad ( 2.5 \text{.1} b )$$

$${\sum }_{l ∈ Ω} {θ}_{l} \leq K \qquad ( 2.5 \text{.1} c )$$

In (2.5.1a), the cost of the driver routes used is minimized. Constraint (2.5.1b) ensures that each duty is covered by a driver, and constraint (2.5.1c) ensures that no more than K driver routes are selected.

In some embodiments, a solution to the bus driver scheduling problem corresponds to a solution that minimizes a cost of a plurality of routes such that (a) each of the plurality of routes comprises a plurality of duties, (b) each of the plurality of duties starts and ends at one of a set of break stations and is covered by a bus driver, and (c) a number of bus drivers is less than or equal to a maximum number of bus drivers.

### 2.6 the Supply Chain Scheduling Problem

In some embodiments, the described CG-based optimization solutions can be applied in the context of the supply chain scheduling problem. The supply chain scheduling problem considers scheduling a set of shipments between different nodes of a supply chain network. Each shipment has a fixed departure time, as well as an origin and a destination node, which, when combined, determine the duration of the associated trip. The aim is to schedule as many shipments as possible, while also minimizing the number of vehicles utilized for this purpose.

The supply chain formulation can be understood as a capacitated vehicle routing problem where each customer has an earliest time that a delivery can be made to them and a linear penalty for each unit of time that it is late. The formulation for the CVRP described in section 2.1 may be employed without a constraint on the maximum number of vehicles used, and interpreting the “customer” in the CVRP framework as an item picked up at the manufacturing facility and taken to another facility.

Here, the cost is given as:

cᵢ=Σ_{u∈N}aᵤₗwᵤ(tᵤₗ-tᵤ)

Herein, aᵤₗ=1 if route l services customer u, to is the earliest start time of customer u, wᵤ is used to denote the importance of u, and tᵤₗ denotes the time that u is dropped off on route l (and tᵤₗ=0 is interpreted as the route l not servicing customer u). Thus, the optimization for the supply chain scheduling problem can be formulated as:

$${min}_{θ \geq 0} {\sum }_{l ∈ Ω} {c}_{l} {θ}_{l} \qquad ( 2.6 \text{.1} a )$$

$${\sum }_{l ∈ Ω} {a}_{ul} {θ}_{l} \geq 1 \qquad ( 2.6 \text{.1} b )$$

In (2.6.1a), the total cost of the routes selected in minimized, and (2.6.1b) ensures that each customer is covered at least once. In the context of FIGS. 1A and 1, the master problem schedules the maximum possible number of shipments using only a small set of vehicle-routes, and the sub-problem generates cost-effective vehicle-routes to be fed into the master problem.

In some embodiments, a solution to the supply chain scheduling problem corresponds to a solution that minimizes a cost of a plurality of routes such that each of the plurality of routes services at least one customer of a plurality of customers within a corresponding window start time and a corresponding window end time, wherein the cost comprises a linear penalty for each time unit the at least one customer is serviced after the corresponding window start time.

### 2.7 the Workforce/Shift Scheduling Problem

In some embodiments, the described CG-based optimization solutions can be applied in the context of the workforce scheduling or shift scheduling problem. In an example, the shift and workforce scheduling problem can be understood in terms of a nurse scheduling framework (and is applicable, without loss of generality, to other scenarios, e.g., factory workers).

Herein, there are a set of duties that need to be covered by a set of nurses, with each nurse having specific skills. A feasible nurse schedule is governed by feasibility within a day as well as feasibility over week ranges (e.g., 5 days on followed by at least 2 days off, as an example of a simple constraint). The set of nurses is denoted by F and indexed by f, N is used to denote the set of tasks that can be serviced by nurses and indexed by u, and there must be at least bᵤ nurses servicing task u, where bᵤ is specific to the problem domain. Furthermore, Ω_{f} denotes the set of feasible schedules (called routes) for nurse f that is indexed by l, θₗ=1 denotes that route (or schedule) l is selected, and cₗ is used to denote the cost of route l, which is problem domain specific. Thus, the optimization for the nurse scheduling problem can be formulated as:

$${min}_{θ \geq 0} {\sum }_{l ∈ Ω} {c}_{l} {θ}_{l} \qquad ( 2.7 \text{.1} a )$$

$${\sum }_{l ∈ Ω} {a}_{ul} {θ}_{l} \geq {b}_{u} \qquad ( 2.7 \text{.1} b )$$

$${\sum }_{l ∈ {Ω}_{f}} {θ}_{l} = 1 \qquad ( 2.7 \text{.1} c )$$

In (2.7.1a), the total cost of the routes selected is minimized, (2.7.1b) ensures that each task is covered by the minimum number of selected nurses, and (2.7.1c) ensures that each nurse is assigned exactly one schedule.

In some embodiments, a solution to the worker scheduling problem corresponds to a solution that minimizes a total cost of a plurality of schedules such that (a) each of the plurality of schedules assigns one or more of a plurality of workers to a task, and (b) each of the plurality of workers is assigned exactly one schedule of the plurality of schedules.

### 2.8 the Micro-Fulfillment in Grocery Stores Problem (MFGP)

In some embodiments, the detour-DOI optimization solution can be applied in the context of the micro-fulfillment in grocery stores problem. In MFGP, the goal is to minimize the travel cost subject to the constraint that all orders are serviced. The travel cost is ideally the total distance traveled by robots; but the surrogate we use is the number of times a robot visits an aisle (summing over robot/aisle pairs) is used as a surrogate, and allows near exact solutions and permits efficient optimization. This is a good surrogate because for a robot traveling through multiple aisles the total distance traveled is empirically mostly intra-aisle travel not inter aisle.

A column is defined by a set of orders and visiting a set of aisles to cover those orders. The cost of the column is the number of aisles visited by the robot servicing those orders. Each robot is restricted to a maximum number of orders serviced. Orders consist of multiple items and the robot must visit an aisle containing each item on its corresponding orders. Optimization groups orders together such that orders that are grouped together can be serviced by a small number of aisles. Pricing insider column generation is a small-scale integer linear program. Specifically, each (order, column) pair in the restricted master problem (RMP) is associated with the minimal number of additional aisles needed to be visited to service that order (ignoring capacity of the robot). Additional primal variables are added in the RMP corresponding to making robots service such orders. The new RMP is structured such that the addition of these variables does not weaken the LP relaxation but does accelerate optimization.

Herein, N, I, K, Ω denote the sets of orders, items, aisles, and routes, respectively, which are indexed by u, i, k, l, respectively. The mapping of orders to aisles/items are described using binary-valued terms bᵢₖ (which is 1 if item i is found on aisle k, and 0 otherwise) and bᵢᵤ (which is 1 if item i is contained in order u, and 0 otherwise). This scenario assumes that an item i can be found in more than one aisle and be in more than one order. In an example, the system includes J homogenous robots each with the capacity to service D orders where J, D are user defined. In another example, the robots are distinct (not homogenous) and the i-th robot has the capacity to service Dᵢ orders. The set of routes Ω is described using binary-valued terms aᵤₗ (which is 1 if route l services order u, and 0 otherwise) and aₖₗ (which is 1 if route l visits aisle k, and 0 otherwise). The cost of using route l is defined as:

$${c}_{l} = {\sum }_{k ∈ K} {a}_{kl} \\ ∀ l ∈ Ω \qquad ( 2.8 \text{.1} )$$

A feasible route is defined as obeying the capacity of a robot and servicing all items in orders in the route. The relevant constraints are:

$${\sum }_{u ∈ N} {a}_{ul} \leq D \\ ∀ l ∈ Ω \qquad ( 2.8 \text{.2} )$$

$${a}_{ul} \leq {\sum }_{k ∈ K} {b}_{ik} {b}_{iu} {a}_{kl} \\ ∀ l ∈ Ω , u ∈ N , i ∈ I \qquad ( 2.8 \text{.3} )$$

Herein, (2.8.2) ensures that no more than D orders are serviced, and (2.8.3) ensures that all items in orders in the route must be included in aisles on that route. The MFGP can be formulated as a set cover problem with a side constraint that no more than J robots are used. A decision variable θₗ=1 is used to indicate the selection of route l. The LP relaxation can be determined, with the dual variables written next to the associated constraints, as:

$${min}_{θ \geq 0} {\sum }_{t ∈ Ω} {c}_{l} {θ}_{l} \qquad ( 2.8 \text{.4} a )$$

$${\sum }_{l ∈ Ω} {θ}_{l} {a}_{ul} \geq 1 \\ ∀ u ∈ N [ {π}_{u} ] \qquad ( 2.8 \text{.4} b )$$

$${\sum }_{l ∈ Ω} {θ}_{l} \leq J [ - {π}_{0} ] \qquad ( 2.8 \text{.4} c )$$

The optimization of (2.8.4) is tackled using column generation (CG). Using ci to denote the reduced cost of l, the pricing can be determined as:

$${min}_{l ∈ Ω} {\overline{c}}_{l} \qquad ( 2.8 \text{.5} a )$$

$${\overline{c}}_{l} = {c}_{l} + {π}_{0} - {\sum }_{u ∈ N} {π}_{u} {a}_{ul} \\ ∀ l ∈ Ω \qquad ( 2.8 \text{.5} b )$$

The pricing problem in (2.8.5) can be formulated as an integer linear program (ILP), and determined as:

$${min}_{\begin{matrix}x ∈ \{ 0 , 1 \} \\ y ∈ \{ 0 , 1 \}\end{matrix}} {π}_{0} + {\sum }_{k ∈ K} {y}_{k} - {\sum }_{u ∈ N} {x}_{u} {π}_{u} \qquad ( 2.8 \text{.6} a )$$

$${x}_{u} \leq {\sum }_{k ∈ K} {b}_{ik} {b}_{ui} {y}_{k} \\ ∀ u ∈ N , i ∈ I \qquad ( 2.8 \text{.6} b )$$

$${\sum }_{u ∈ N} {x}_{u} \leq D \qquad ( 2.8 \text{.6} c )$$

Herein, (2.8.6a) is the objective corresponding to ci, (2.8.6b) ensures that every item is covered in a given selected order, and (2.8.6c) ensures that no more than D orders are serviced.

In some embodiments, a solution to the MFGP corresponds to a solution to a robot routing problem that reduces or minimizes a sum of a number of aisles on each route of a plurality of routes, wherein one or more routes of a plurality of routes for each of the plurality of robots (a) starts and ends at the depot location, (b) visits each item location associated with each of the corresponding plurality of orders, and (c) services a capacity that does not exceed each robot's capacity to service a corresponding fixed number of orders.

### 3 Example Embodiments of CG-Based Optimization Methods

The disclosed technology provides, inter alia, different CG-based optimization methods that can be applied to one or more of the applications discussed in sections 2.1-2.7. The disclosed CG-based optimization methods significantly improve the computational speed of CG solvers by reducing the complexity associated with solving the RMP or the pricing problem compared to existing implementations.

### 3.1 Dual Optimal Inequalities Incorporating Detours (Detour-DOI)

Detour-DOI uses an alternative primal master formulation for the underlying optimization problem (e.g., the CVRP) such that the alternative formulation is augmented with additional primal variables/constraints. The relaxation used in detour-DOI (DT-DOI) is exactly as tight as the standard set cover relaxation, and hence at the termination of CG (at optimality), the results produced are identical to standard CG. However, prior to convergence of CG this relaxation produces a value between those of the MP and the standard RMP and thus permits CG to converge faster.

We now provide additional notation used to express DT-DOI. We use decision variable yᵤₗ∈[0,1] to indicate the decision to make detour to service item u on route l. This detour is made at the closest item (or depot) on the route l to u. If the detour is made at item v then the corresponding vehicle reaches v then visits u then returns to v then proceeds on its route. We set yᵤₗ=1 if we make a detour on route l to service item u. Note that yᵤₗ may be set to one or zero independent of aᵤₗ. If yᵤₗ=aᵤₗ=1 then the item u is serviced as it normally would be on route l. We can understand this as making a detour of distance zero. Similarly if yᵤₗ=0 while aᵤₗ=1 then the route visits u without servicing u. The cost of this detour is written as cᵤₗ where cᵤₗ=2*the minimum distance from an item v∈Nₗ (or the starting/ending depot) to u. We write this formally below (recall −1, −2 denote the start/end depot respectively; which are typically the same place).

$${c}_{ul} = 2 {min}_{v ∈ {N}_{l} + ( - 1 ) + ( - 2 )} {c}_{uv} \qquad ( 3.1 \text{.1} )$$

We use decision variables ψₗ ∈[0,1] to indicate the selection of a route using detours. We set ψₗ=1 to select route l augmented with the ability to make detours. We use [symbol] to denote the set of unique demands of items. We define D_{dl} to be the number of items in route l of demand at least d meaning D_{dl}=Σ_{u∈N} [dᵤ≥d]aᵤₗ for all l∈Ω, d∈ [symbol] . We now write our primal master problem below with exposition afterwords.

$${min}_{\begin{matrix}θ \geq 0 \\ ψ \geq 0 \\ y \geq 0\end{matrix}} {\sum }_{l ∈ Ω} {c}_{l} {θ}_{l} + {\sum }_{l ∈ Ω} {c}_{l} {ψ}_{l} + {\sum }_{\begin{matrix}u ∈ N \\ l ∈ Ω\end{matrix}} {c}_{ul} {y}_{ul} \qquad ( 3.1 \text{.2} a )$$

$${\sum }_{l ∈ Ω} {y}_{ul} + {\sum }_{l ∈ Ω} {a}_{ul} {θ}_{l} \geq 1 \\ ∀ u ∈ N [ {π}_{u} ] \qquad ( 3.1 \text{.2} b )$$

$${y}_{ul} \leq {ψ}_{l} \\ ∀ u ∈ N , l ∈ Ω [ - {π}_{ul} ] \qquad ( 3.1 \text{.2} c )$$

$${\sum }_{u ∈ N} [ {d}_{u} \geq d ] {y}_{ul} \leq {D}_{dl} {ψ}_{l} \\ ∀ l ∈ Ω , d ∈ 𝒟 [ - {π}_{dl} ] \qquad ( 3.1 \text{.2} d )$$

$${\sum }_{l ∈ Ω} {θ}_{l} + {\sum }_{l ∈ Ω} {ψ}_{l} \leq K [ - {π}_{0} ] \qquad ( 3.1 \text{.2} e )$$

In (3.1.2a), the total cost of the routes and detours taken is minimized. (3.1.2b) enforces that an item is covered at least once by a detour or a route without detours, (3.1.2c) enforces that a detour on a given route is taken only if that route is selected, (3.1.2d) enforces that each route is feasible with respect to demand. Specifically, a route not servicing more items with demand greater than or equal to any given amount than it services in the original route (where the original route is associated with θₗ) is enforced. (3.1.2e) enforces that no more than K vehicles are used. The dual of (3.1.2) may be determined similar to the derivation described in section 2. Column generation is used to solve (3.1.2), wherein Ω is replaced with Ωᵣ. It is noted that pricing over Ω is unaffected and is still done using (2.8.5). Note that no pricing is done over yᵤₗ or ψₗ. This is because once l is added to Ωᵣ via (2.8.5), ψₗ and yᵤₗ (∀u∈N) are added for consideration in the RMP. If it becomes the case that the RMP becomes difficult to solve we can decrease the number of yᵤₗ terms or ψₗ terms considered.

In some embodiments, using detour-DOI results in a plurality of optimized routes such that at least one optimized route of the plurality of optimized routes comprises a detour consisting of [i] a first segment from a first item location associated with a first item of the plurality of items to a second item location associated with a second item of the plurality of items and [ii] a second segment from the second item location to the first item location.

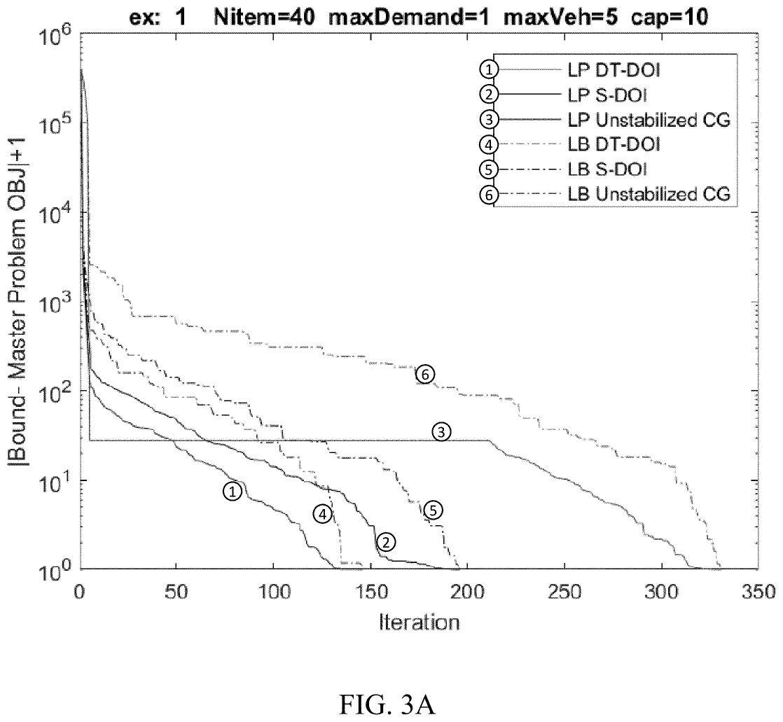

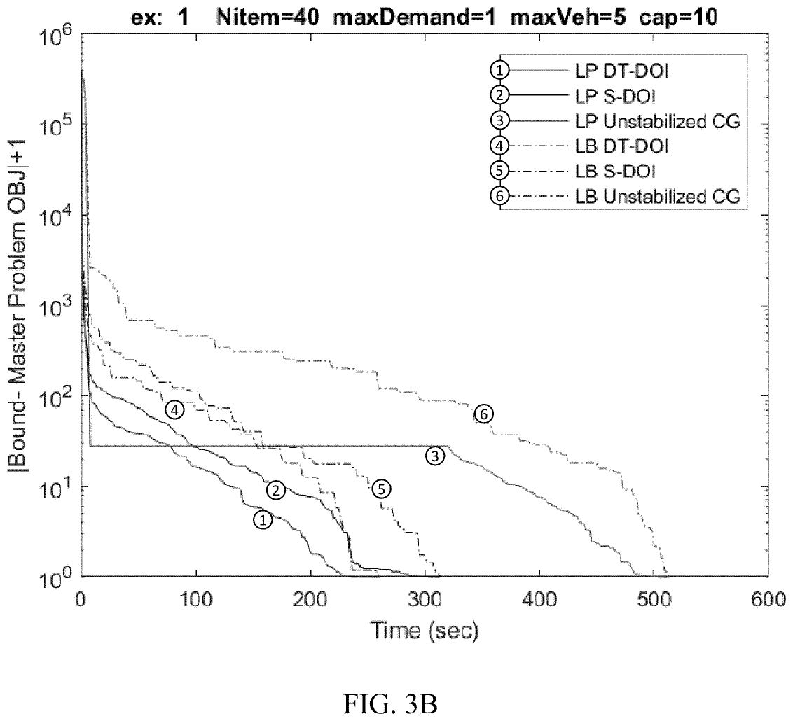

Experimental evidence supporting the use of Detour-DOI (DT-DOI) for accelerating column generation (CG) on the Capacitated Vehicle Routing Problem (CVRP) is shown in Tables 1 and 2, and FIGS. 3A and 3B. The performance of DT-DOI is compared to Smooth-DOI (S-DOI) and un-stabilized CG. Comparisons are made with regard to time and iterations to solve the linear programming relaxation of set cover for the CVRP.

Fourteen randomly generated instances of the following form were used. Each problem instance is associated with 40 items of demand one and 5 vehicles of capacity 10 each. Each item and the starting depot is assigned a random integer position on grid of size 100 by 100. Distances between items (and depots) are computed based on the L2 distance rounding up to the nearest integer. The starting depot is located at the same place as the ending depot.

TABLE 1
DT-DOI runtime results for CVRP

| | Time | | | Speedup | |
|---|---|---|---|---|---|
| Instance | un-stabilized CG | DT-DOI | S-DOI | DT-DOI | S-DOI |
| 1 | 513.2 | 260.9 | 313.2 | 2.0 | 1.6 |
| 2 | 565.3 | 210.7 | 374.4 | 2.7 | 1.5 |
| 3 | 723.5 | 227.0 | 379.5 | 3.2 | 1.9 |
| 4 | 975.8 | 194.9 | 552.9 | 5.0 | 1.8 |
| 5 | 927.4 | 390.6 | 558.0 | 2.4 | 1.7 |
| 6 | 626.0 | 285.7 | 403.5 | 2.2 | 1.6 |
| 7 | 594.7 | 247.0 | 360.2 | 2.4 | 1.7 |
| 8 | 656.4 | 244.9 | 382.1 | 2.7 | 1.7 |
| 9 | 674.5 | 299.8 | 397.6 | 2.3 | 1.7 |
| 10 | 823.8 | 270.5 | 529.8 | 3.0 | 1.6 |
| 11 | 999.0 | 272.9 | 641.9 | 3.7 | 1.6 |
| 12 | 760.2 | 353.9 | 503.9 | 2.1 | 1.5 |
| 13 | 584.7 | 338.9 | 425.5 | 1.7 | 1.4 |
| 14 | 1270.6 | 188.6 | 598.0 | 6.7 | 2.1 |
| mean | 763.9 | 270.4 | 458.6 | 3.0 | 1.7 |
| median | 699.0 | 265.7 | 414.5 | 2.5 | 1.6 |

TABLE 2
DT-DOI iteration results for CVRP

| | Iterations | | | Iteration Speedup | |
|---|---|---|---|---|---|
| Instance | un-stabilized CG | DT-DOI | S-DOI | DT-DOI | S-DOI |
| 1 | 331 | 146 | 196 | 2.3 | 1.7 |
| 2 | 347 | 109 | 203 | 3.2 | 1.7 |
| 3 | 341 | 103 | 176 | 3.3 | 1.9 |
| 4 | 410 | 93 | 205 | 4.4 | 2.0 |
| 5 | 331 | 118 | 170 | 2.8 | 1.9 |
| 6 | 346 | 144 | 213 | 2.4 | 1.6 |
| 7 | 322 | 125 | 189 | 2.6 | 1.7 |
| 8 | 297 | 111 | 172 | 2.7 | 1.7 |
| 9 | 320 | 137 | 189 | 2.3 | 1.7 |
| 10 | 439 | 144 | 290 | 3.0 | 1.5 |
| 11 | 454 | 132 | 279 | 3.4 | 1.6 |
| 12 | 350 | 145 | 209 | 2.4 | 1.7 |
| 13 | 294 | 140 | 201 | 2.1 | 1.5 |
| 14 | 533 | 97 | 235 | 5.5 | 2.3 |
| mean | 365.4 | 124.6 | 209.1 | 3.0 | 1.8 |
| median | 343.5 | 128.5 | 202 | 2.7 | 1.7 |

As seen in Tables 1 and 2 and FIGS. 3A and 3B, large speed ups with regard to both timing and iterations are seen for DT-DOI, thereby showing the technical improvement over existing implementations with regard to, inter alia, complexity reduction (e.g., reduced number of iterations required for DT-DOI).

### 3.2 Graph Generation (GG)

In some embodiments, graph generation is able to solve the restricted master problem (RMP) over larger sets than we can explicitly enumerate given the same number of calls to pricing as standard column generation. This accelerates the convergence of optimization as fewer rounds of pricing are required. Graph generation does not weaken the LP relaxation, but at any given iteration of CG permits the restricted master problem (RMP) to express a much wider set of columns permitting faster convergence. As noted, graph generation is focused on solving the RMP, and does not affect the pricing problem (or subproblem).

In some embodiments, graph generation uses families of columns, and in particular, the union of columns in the families of columns (denoted Ω_{R2}) to provide the improvement in convergence. In an example, solving Ψ(Ω_{R2}) efficiently at each stage of the RMP of CG accelerates the convergence of CG, wherein Ψ(Ω_{R2}) is determined as:

$$Ψ ( {Ω}_{R 2} ) = {min}_{\begin{matrix}θ \geq 0 \\ ψ \geq 0\end{matrix}} {\sum }_{l ∈ {Ω}_{R}} {c}_{l} {θ}_{l} + {\sum }_{\begin{matrix}f ∈ {F}_{R} \\ ij ∈ {E}^{j}\end{matrix}} {c}_{ij}^{f} {ψ}_{ij}^{f} \qquad ( 3.2 \text{.1} )$$

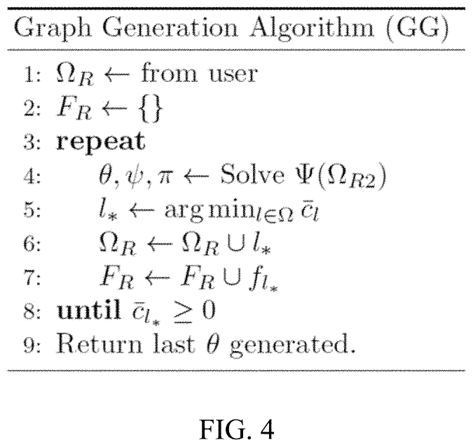

In (3.2.1), F_{R} is the union of columns in the families of columns in Ω_{R}, and E^{f} is the edge set associated with the encoding of the families of columns using a path cone. An example algorithm for graph generation is shown in FIG. 4, which is annotated as follows:

Lines 1-2: Initialize CG with columns from the user, which may consist of artificial variables with prohibitively high cost that ensure a feasible solution exists. Initialize F_{R} to Ω_{R}. If artificial primal variables (columns) are provided in Ω_{R} then these are not added to F_{R}.

Line 3-8: Generate a sufficient set of columns/graphs to solve the MP exactly
Line 4: Solve the RMP providing a primal/dual solution
Line 5: Call pricing to generate the lowest reduced cost column l*. As in basic column generation we can generate more than one column
Lines 6-7: Add the new column l* and the associated family f₁* to the RMP
Line 8: If no column has negative reduced cost, terminate optimization

Line 9: Return last primal solution generated which is optimal. As in basic CG this can be returned to a branch-price algorithm, that uses the GG algorithm shown in FIG. 4 as an inner loop operation.

In some embodiments, the graph generation method includes a column generation method, wherein the column generation method comprises adding a column to the master problem as part of solving the subproblem, wherein the column corresponds to a particular route with a topological ordering of items serviced by a particular vehicle on the particular route, wherein the graph generation method further comprises adding a family of the column to the master problem, and wherein the family of the column corresponds to one or more routes that maintain the topological ordering of the items serviced by the particular route and do not exceed the capacity of the particular vehicle.

Experimental evidence supporting the use of graph generation for accelerating column generation (CG) on the Capacitated Vehicle Routing Problem (CVRP) is shown in Tables 3 and 4. The performance of graph generation is compared to un-stabilized CG. Comparisons are made with regard to time and iterations to solve the linear programming relaxation of set cover for the CVRP.

Twenty-five randomly generated instances of the following form were used. Each problem instance is associated with 30 items of demand one and 5 vehicles of capacity 7 each. Each item and the depot is assigned a random integer position on grid of size 100 by 100. Distances between items (and the depot) are computed based on the L2 distance rounding up to the nearest integer.

TABLE 3
GG iteration results for CVRP

Iterations

| Instance | un-stabilized CG | Graph Generation |
|---|---|---|
| 1 | 110 | 28 |
| 2 | 92 | 20 |
| 3 | 92 | 22 |
| 4 | 151 | 23 |
| 5 | 145 | 17 |
| 6 | 96 | 25 |
| 7 | 95 | 37 |
| 8 | 119 | 18 |
| 9 | 92 | 25 |
| 10 | 123 | 12 |
| 11 | 188 | 50 |
| 12 | 245 | 42 |
| 13 | 356 | 26 |
| 14 | 164 | 52 |
| 15 | 214 | 50 |
| 16 | 155 | 63 |
| 17 | 177 | 50 |
| 18 | 208 | 59 |
| 19 | 354 | 42 |
| 20 | 177 | 48 |
| 21 | 194 | 63 |
| 22 | 144 | 36 |
| 23 | 350 | 32 |
| 24 | 182 | 48 |
| 25 | 215 | 41 |
| mean | 177.5 | 37.2 |
| median | 164 | 37.0 |

TABLE 4
GG runtime results for CVRP

Time (seconds)

| Instance | Un-Stabilized CG | Graph Generation |
|---|---|---|
| 1 | 55.9 | 21.6 |
| 2 | 20.5 | 7.9 |
| 3 | 41.5 | 11.3 |
| 4 | 113.7 | 13.6 |
| 5 | 91.8 | 8.4 |
| 6 | 74.0 | 24.3 |
| 7 | 51.5 | 67.0 |
| 8 | 71.0 | 14.6 |
| 9 | 27.6 | 20.2 |
| 10 | 78.1 | 5.8 |
| 11 | 513.3 | 206.8 |
| 12 | 599.7 | 152.0 |
| 13 | 1079.0 | 94.7 |
| 14 | 386.9 | 202.1 |
| 15 | 573.8 | 213.1 |
| 16 | 330.5 | 249.5 |
| 17 | 331.2 | 165.4 |
| 18 | 397.3 | 230.6 |
| 19 | 846.7 | 124.5 |
| 20 | 352.2 | 147.9 |
| 21 | 415.8 | 258.7 |
| 22 | 371.0 | 121.2 |
| 23 | 692.5 | 91.7 |
| 24 | 361.4 | 162.8 |
| 25 | 639.2 | 175.3 |
| mean | 340.6 | 111.6 |
| median | 352.2 | 121.2 |

As seen in Tables 3 and 4, GG consistently outperforms CG in terms of both time and iterations, thereby showing the technical improvement over existing implementations with regard to, inter alia, complexity reduction (e.g., reduced number of iterations required for GG).

### 3.3 Principled Graph Management (PGM)

Embodiments of the disclosed technology are directed to principled graph management (PGM), which is an accelerated version of graph generation (GG) for problems in which solving the restricted master problem (RMP), instead of the pricing problem, is the bottleneck. Principled graph management does not weaken the LP relaxation of GG, and exploits the following properties of the graph generation RMP: (a) the addition of a small number of edges to a GG graph has the effect of adding a large number of columns of the expanded LP relaxation to the GG RMP without significantly increasing GG RMP solution time; (b) most edges are not active in the final solution to the GG RMP at any iteration of GG; and (c) computing the lowest reduced cost column associated with any graph is a simple shortest path problem not a resource constrained shortest path problem as in pricing.

PGM relies on similar notation as in the case of GG (and described in section 3.2), with Ψ(Ω_{R2}) being determined as:

$$Ψ ( {Ω}_{R 2} ) = {min}_{ψ \geq 0} {\sum }_{\begin{matrix}f ∈ {F}_{R} \\ ij ∈ {E}^{f}\end{matrix}} {c}_{ij}^{f} {ψ}_{ij}^{f} \qquad ( 3.3 \text{.1} )$$

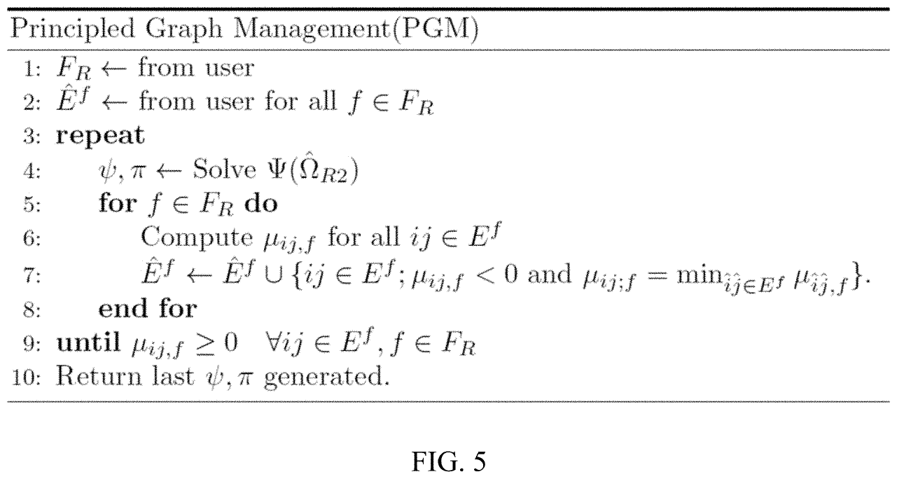

An example algorithm for principled graph management is shown in FIG. 5, which is annotated as follows:
Line 1-2: Initialize F_{R} and {Ê^{f}, ∀f∈F_{R}} to include a feasible solution to (3.3.1). The selected edges are those used in the optimal primal solution to the previous solution to the RMP (if this is not the first iteration of GG). If it is the first iteration of GG then any edges describing a feasible solution to the RMP are sufficient. Such a choice can include artificial variables.
Line 3-9: Construct sufficient sets of edges Ê^{f} for all f∈F_{R}s.t. Ψ(\hat{Ω}_{R2})=Ψ(Ω_{R2})
   Line 4: Solve Ψ(\hat{Ω}_{R2}) providing a dual solution to the RMP over edge sets Ê^{f} for each f∈F_{R}
   Line 5-8: Add any edges included in a column with lowest reduced cost (for that family); and that has negative reduced cost.
      Line 6: Compute μ_{ij;f} for each i, j∈E^{f}. We show how to do this efficiently subsequently in this section.
      Line 7: Add any edges to Ê^{f} for which μ_{ij;f} is minimized (and is negative valued).
      Line 9: Terminate the optimization when μ_{ij;f}≥0 for all i, j∈E^{f}, f∈F_{R} meaning that we have produced an optimal solution to the RMP.
Line 10: Return the solution of the RMP

In some embodiments, the principled graph management method includes a graph generation method, wherein the graph generation method comprises a column generation method, wherein the column generation method comprises adding a column to the master problem as part of solving the subproblem, wherein the column corresponds to a particular route with a topological ordering of items serviced by a particular vehicle on the particular route, wherein the graph generation method further comprises adding a family of the column to the master problem, wherein the family of the column corresponds to one or more routes that maintain the topological ordering of the items serviced by the particular route and do not exceed the capacity of the particular vehicle, wherein the principled graph management method further comprises adding one or more edges, associated with the family of the column, to the master problem to generate an alternative master problem, and wherein every solution of the alternative master problem is a solution to the master problem.

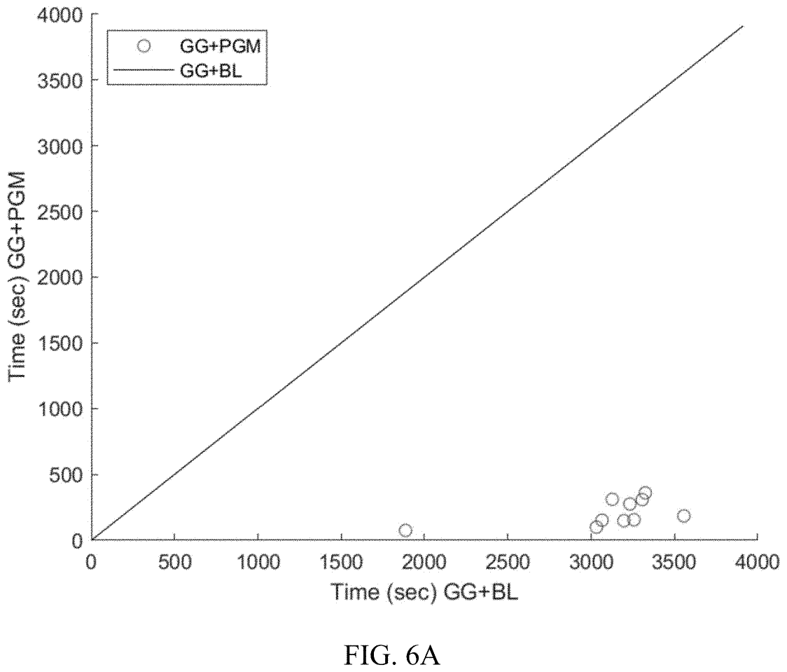

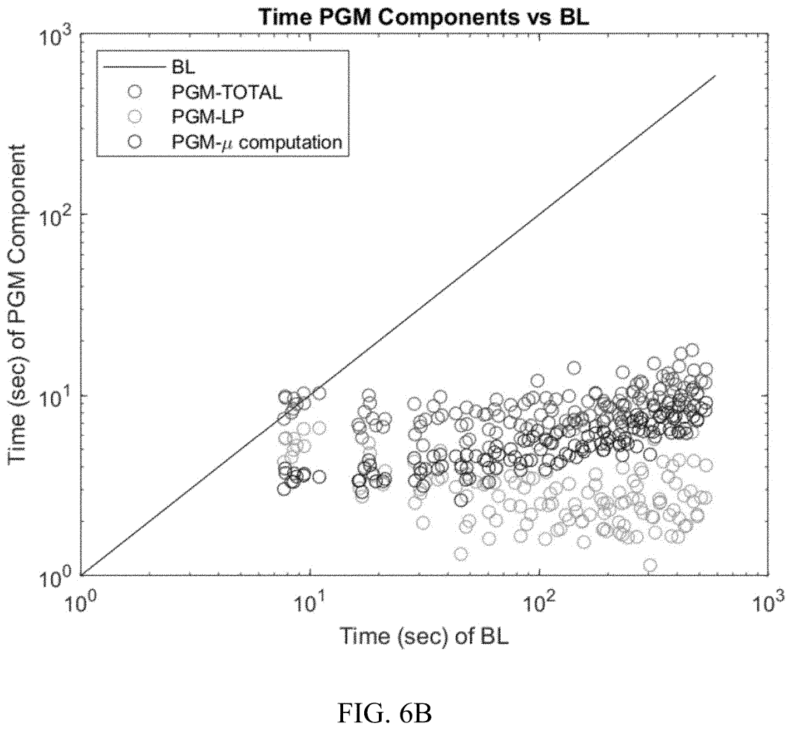

Experimental evidence supporting the use of PGM for accelerating graph generation (GG) on the Capacitated Vehicle Routing Problem (CVRP) is shown in FIGS. 6A and 6B. The performance of PGM (in conjunction with GG, i.e., GG+PGM) is compared to a baseline solver (denoted BL and in conjunction with GG, i.e., GG+BL). Comparisons are made with regard to time required to solve each problem instance up till heuristic pricing fails to generate a negative reduced cost column (at which point the reduced cost of the column generated is regarded as zero and GG is terminated).

Ten randomly generated instances of the following form were used. 150 customers are placed randomly according to a uniform distribution on a 50 by 50 grid each of demand one. We have access to 40 vehicles each of capacity 6. The depot is placed randomly as well according to a uniform distribution. All distances between customers (and or the depot) use the L2 distance which is rounded up to the nearest integer.

The aggregated results of this experiment over all problem instances in the data set are shown in FIG. 6A. Each data point describes the time taken for that problem instance to be solved by GG+PGM vs GG+BL. To provide a baseline for improvement, a black line describing the linear function with slope=1 and y intercept=0 is plotted. The further below the line a dot is placed the greater corresponding performance improvement achieved by GG+PGM over GG+BL. As seen in FIG. 6A, PGM converges faster than GG, and is able to (approximately) solve problem all problem instances within the time limit, while GG+BL is only able to approximately solve one problem instance.

A comparison of the time required to solve the RMP generated by GG+PGM at each iteration by PGM vs BL is shown in FIG. 6B (aggregated over all problem instances). For each iteration of PGM/problem instance we provide three data points, where the x coordinate corresponds to the time for the RMP to be solved using the BL, and the y coordinate corresponds to the total time for PGM to solve the RMP. As seen in FIG. 6B, the time to solve the RMP differs widely for BL while being relatively constant and much smaller for PGM. In nearly all cases PGM takes less time than BL; and in the cases that PGM take more time than BL are in the regime is the smallest time regime studied. In the high computation time regime for GG, a factor of 50 speedup is observed by using PGM over BL. If only solving the LP is considered, speed factors up to 266 are observed.

### 3.4 Local Area (LA) Routes

Exact solutions to vehicle routing problems (e.g., the CVRP described in section 2.1) are traditionally formulated as weighted set cover problems where each customer must be covered, and routes describe feasible sets with the cost of a set being the cost of the route. Since the number of such routes grows exponentially in the number of customers, CG methods are applied so that the set of routes need not be explicitly enumerated. CG methods imitate the revised simplex approach and generate primal variables during pricing (called columns) on demand, which is tackled as a combinatorial optimization problem.

In such problems, solving the CG pricing problem to generate routes for the CG restricted master problem (RMP) is especially problematic since the routes produced must be elementary (meaning that no customer is visited more than once in the route). The described technology provides, inter alia, a class of routes known as Local Area (LA) routes that are easy to price over, and can be used to efficiently generate elementary routes when used inside Decremental State Space Relaxation (DSSR).

An LA route is a route in which elementarity is relaxed, but not by much due to other constraints. The set of LA routes does not include routes with cycles localized in space; where a cycle is a section of a route consisting of the same customer at the start and end of the section. Localized cycles in space are cycles consisting of customers which are all spatially close to one another. LA routes are a subset of the popular ng-routes (and a superset of elementary routes). Ng-routes are a part of many efficient and modern CG algorithms for vehicle routing problems. Both LA routes and ng-routes can be used inside DSSR to produce exact solutions to pricing over elementary routes.

Efficient pricing over LA routes exploits the following three properties:

1. For each w∈\hat{N}, v∈\hat{N}, \hat{N}⊆Nᵤ we can compute the lowest cost elementary path starting at u ending at w and visiting all customers in \hat{N}. The order of customers in this path does not change as a function of the dual variables. The size of the sets Nᵤ is selected to be small enough (10-20) to permit all such terms to be computed in advance of CG (not at each iteration of CG). This is done as a dynamic program.

2. Given any u∈N, v∈(N∪−2)−(Nᵤ ∪u), \hat{N}⊆Nᵤ (where N is the set of all customers) we can compute the lowest cost elementary path starting at u ending at v and servicing all intermediate customers in \hat{N} using the material computed in bullet point 1. The order of customers in this path does not change as a function of the dual variables. This computed once at the beginning of CG, not at each iteration of CG.

3. Given any u∈N, v∈(N∪−2)−(Nᵤ ∪u), d≥dᵤ we can at each iteration of CG during pricing, efficiently compute the lowest reduced cost elementary path starting at u, ending at v, servicing only intermediate customers in Nᵤ and servicing d units of demand (including u not v). The membership and the ordering (given the membership) of this path does not change as a function of the dual variables (by bullet point 2).

In some embodiments, LA routes can be defined in terms of ng-routes. In a formal description of LA routes, the following terms are associated with each customer u∈N. Let Nᵤ and Mᵤ refer to two classes of neighboring customers of u, which are referred to as the LA neighbors and the ng-neighbors, respectively. Nᵤ is defined to be a subset of the customers in N which are near u with regard to spatial position. Mᵤ is defined similarly, except that this set may be grown when used with DSSR. By convention, neither Nᵤ or Mᵤ contains u. Also, by convention the starting/ending depot has no ng-neighbors or LA-neighbors; furthermore, no customer considers the starting/ending depot to be a neighbor.

In ng-routes, every cycle starting and ending at a customer u must contain at least one customer that does not consider u to be an ng-neighbor. This property may be expressed as follows:

(u=uₖ_{₁}^{p}=uₖ_{₂}^{p})→∃k₃ s.t. k₁<k₃<k₂ v=uₖ_{₃}^{p} u∉Mᵥ,∀{u∈N,k₁<k₂}

The premise (left side of →) is true if the same customer is at positions k₁ and k₂ and that customer is u. The inference (right side of →) is that there must exist a customer at some position k₃ that lies between k₁ and k₂ and does not consider u to be a neighbor.

In contrast, in LA routes, the property is expressed as follows:

(u=uₖ_{₁}^{p}=uₖ_{₂}^{p})→∃k₃ s.t. k₁<k₃<k₂, k₃∈Q^{p}, v=uₖ_{₃}^{p}, u∉Mᵥ∀{u∈N,k₂<k₁}

The premise (left side of →) is true if the same customer is at positions k₁ and k₂ and that customer is u. The inference (right side of →) is that there must exist a customer at special index k₃ that lies between k₁ and k₂ and does not consider u to be a neighbor.

The property that a path must satisfy to be an LA route is as follows: every cycle starting and ending at a customer u must contain at least one customer at a special index that does not consider u to be a ng-neighbor. This is in contrast to ng-routes where that customer does not have to be at a special index. Thus, LA routes are a subset of ng-routes and a super-set of elementary routes. The CVRP LP relaxation over LA routes is no looser and potentially tighter than the ng-route relaxation (given a fixed set of ng-neighbors for each customer).

We now consider an example of ng-routes that are not LA routes. In our example, the set Nᵤ is identical to the set Mᵤ for each u∈N, |N|=12, and the locations of the twelve customers correspond to the set of positions on a classic analog clock. As a result, both the LA neighbors and the ng-neighbors of uₖ are [uₖ₋₂, uₖ₋₁, uₖ₊₁, uₖ₊₂] applied with modulus 12. Thus the neighbors (ng and LA) of u₄ (4 o'clock) are Nᵤ_{₄}=[u₂, u₃, u₅, u₆] and the neighbors of u₁ are Nᵤ_{₁}=[u₁₁, u₁₂, u₂, u₃]. Respecting the properties set for our example, the following route is considered to be a feasible ng-route but is not a feasible LA route: −1, u₃, u₁, u₅, u₃, −2. Observe that the set of special indices in our route consists of the indexes 1 and 4, which corresponds to customer u₃.

In some embodiments, the computation of the lowest reduced cost LA route, which can be shown as a shortest path problem that can be trivially solved with Dijkstra's shortest-path algorithm, can be achieved by writing pricing as a sequence of integer linear programs (ILPs); the last ILP corresponds to the generation of the lowest reduced cost LA route as a shortest path problem. To assist in the discussion, define P_{u,v,M}_{₁}_{,M}_{₂}_{,d} to be the set of all elementary paths satisfying the following:
The path starts at u∈N⁺ and ends at v∈N⁺, where u and v are not equal and v is not in the set Nᵤ and not in the set M₁.
No customers in M₁ (which is a subset of Mᵤ) are visited.
All customers in M₂-M₁ are visited where M₂⊆Mᵥ.
No customers in Mᵥ-M₂ are visited.
The total demand serviced is d (excluding v and including u, where the starting/ending depot has no demand) OR if v is the end depot then the total demand serviced (including u) does not exceed d.
All customers visited lie in Nᵤ excluding u, v.
An LA route is a sequence of elementary paths.

The above definition enables the computation of the lowest reduced cost elementary route to be described by an ILP. The elementarity constraint can be ignored to determine the lowest reduced cost LA route as an ILP given as:

$${min}_{x ∈ \{ 0 , 1 \}} {\sum }_{z ∈ Z} {c}_{{p}^{z}} ( {\sum }_{\begin{matrix}ij ∈ E \\ i = ( u , {M}_{1} , {d}_{1} ) \\ j = ( v , {M}_{2} , {d}_{2} ) \\ {d}_{1} - {d}_{2} = d \\ z = ( u , v , {M}_{1} , {M}_{2} , d )\end{matrix}} {x}_{ij} ) \qquad ( 3.4 \text{.1} a )$$

$${\sum }_{u ∈ N} {x}_{- 1 , ( u , \{ \} , {d}_{0} )} = 1 \qquad ( 3.4 \text{.1} b )$$

$${\sum }_{ij ∈ E} {x}_{ij} = {\sum }_{ji ∈ E} {x}_{ji} \\ ∀ i = ( u , {M}_{1} , d ) \qquad ( 3.4 \text{.1} c )$$

The ILP described by (3.4.1) is identical in form to ILPs describing standard shortest path problems. Thus, (3.4.1) can be solved using the Bellman-Ford algorithm to find the shortest path from −1 (the starting depot) and −2 (the ending depot) in E, since E may have negative weights with no negative weight cycles. Since E is a directed acyclic graph, E has no cycles and therefore no negative weight cycles. If E can be transformed to an equivalent representation with no negative edge weights, Dijkstra's algorithm can be applied instead to find the shortest path. Applying Dijkstra's algorithm to an equivalent representation of E (which produces the same path and the same minimal cost) is superior due to the improved asymptotic time complexity of Dijkstra's algorithm compared to the Bellman-Ford algorithm.

In some embodiments, the lowest cost component path terms can be pre-computed, which ensures that pricing using LA routes is computationally fast. This pre-computation is done once prior to any pricing operations and never needs to be updated.

In some embodiments, a column generation method comprises adding a column to the master problem as part of solving the subproblem, wherein the column corresponds to a particular route with a topological ordering of items serviced by a particular vehicle on the particular route, wherein the local area route relaxation comprises an ng-route relaxation, wherein the ng-route relaxation specifies that a first item location is followed by a second item location such that a distance between the first item location and the second item location is greater than a second threshold, wherein the local area route relaxation specifies that the distance between the first item location and the second item location is greater than a third threshold, and wherein the first threshold, second threshold and third threshold are positive numbers. Herein, the distance between the first item location and the second item location is representative of the length of the cycle (on the graph) that includes the first item location and the second item location. As described herein, the cycle for the LA route relaxation is larger (or longer) than the cycle for the ng-route relaxation, which is consistent with LA routes being a subset of ng-routes.

Experimental evidence supporting the use of LA routes for accelerating the solution of the set cover formulation over elementary routes in the Capacitated Vehicle Routing Problem (CVRP) is shown in Tables 6 and 7. The performance of including LA routes is compared to un-stabilized column generation (UCG) and GG+PGM. To determine the value of larger LA neighbor sets, we consider the use of LA neighbor sets of size [0, 5, 10] associated with each customer.

The dataset described in Table 5 is used to demonstrate the efficacy of using LA routes. In this dataset, all customers have unit demand. The number of customers lies in [20, 30, 40, 60] and the vehicle capacity lies in [4,8,10]. For each problem combination over the set of possible customers and the set of possible vehicle capacities, we have up to ten problem instances. In each case, the locations of the customers/depot are generated uniformly over a two-dimensional grid. The number of problem instances of each permutation of capacity/number of customers are shown in Table 5.

TABLE 5
Dataset used to demonstrate efficacy of LA routes

| Vehicle Capacity | Number of Customers | Number of Problem Instances |
|---|---|---|
| 4 | 20 | 10 |
| 4 | 30 | 10 |
| 4 | 40 | 10 |
| 8 | 20 | 10 |
| 8 | 30 | 10 |
| 8 | 40 | 7 |
| 8 | 60 | 1 |
| 10 | 20 | 10 |
| 10 | 30 | 7 |

Table 6 describes the proportion of problem instances for which a given approach achieves at least a Factor Speed up for problem instances requiring at 500 seconds to be solved by the baseline solver. As seen in Table 6, the GG+PGM solvers showcase at least Factor Speed ups of 2 in at least 91.67% of all problem instances, whereas the UCG solvers showcase at least Factor Speed ups of 2 with far less probability. Furthermore, we see that itis likely to achieve Factor Speed ups as large as 10 using our GG+PGM solvers.

TABLE 6
Proportion of problems achieving at least a given speedup
over the baseline as a function of the approach used.

| | | | GG + | GG + | GG + |
|---|---|---|---|---|---|
| Factor | UCG | UCG | PGM | PGM | PGM |
| Speedup | LA = 5 | LA = 10 | LA = 0 | LA = 5 | LA = 10 |
| *1 | 0.6543 | 0.8519 | 1.0000 | 1.0000 | 1.0000 |
| *2 | 0.0247 | 0.2346 | 1.0000 | 0.9753 | 0.9877 |
| *5 | 0 | 0 | 0.7037 | 0.7531 | 0.8519 |
| *10 | 0 | 0 | 0.2346 | 0.2963 | 0.5185 |
| *20 | 0 | 0 | 0.0617 | 0.0988 | 0.2346 |
| *40 | 0 | 0 | 0 | 0.0247 | 0.0741 |
| *60 | 0 | 0 | 0 | 0 | 0.0247 |

Thus, using LA routes provides a significantly technical improvement over existing implementations with regard to, inter alia, complexity reduction (e.g., a higher percentage of instances achieving a speedup when using LA routes).

### 4 Example Implementations of the Disclosed Technology

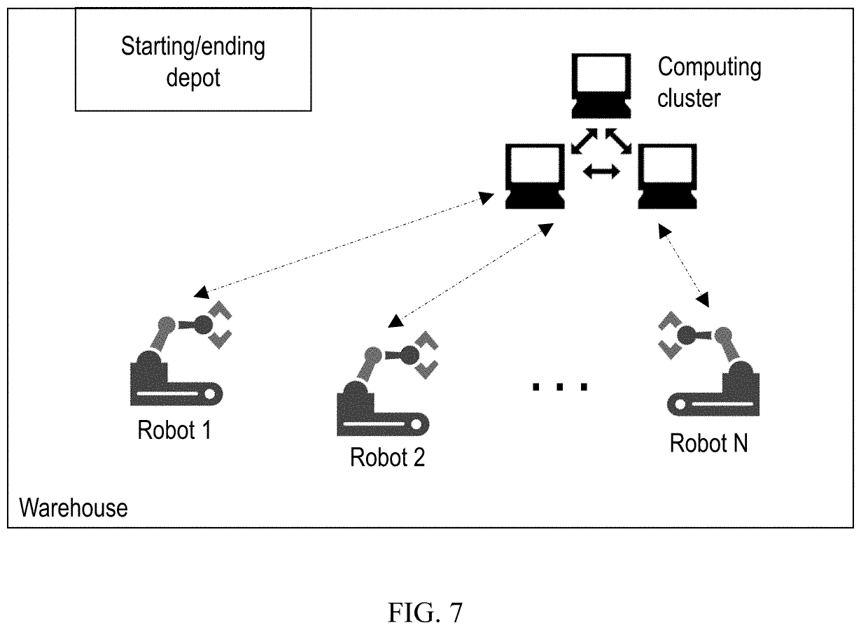

The described embodiments can be applied, for example, to the framework shown in FIG. 7. As shown therein, a set of homogenous robots (or vehicles) are associated with a starting/ending depot, and are configured to service a set of customers with locations and demands. The computing cluster assigns the robots to routes such that all customers are serviced and the capacity of each of the robots is respected. Alternatively, disclosed technology can be applied, for example, to a single robot that is configured to service the set of customers with locations and demands. Herein, the computer cluster assigned a single optimized route to the single robot.

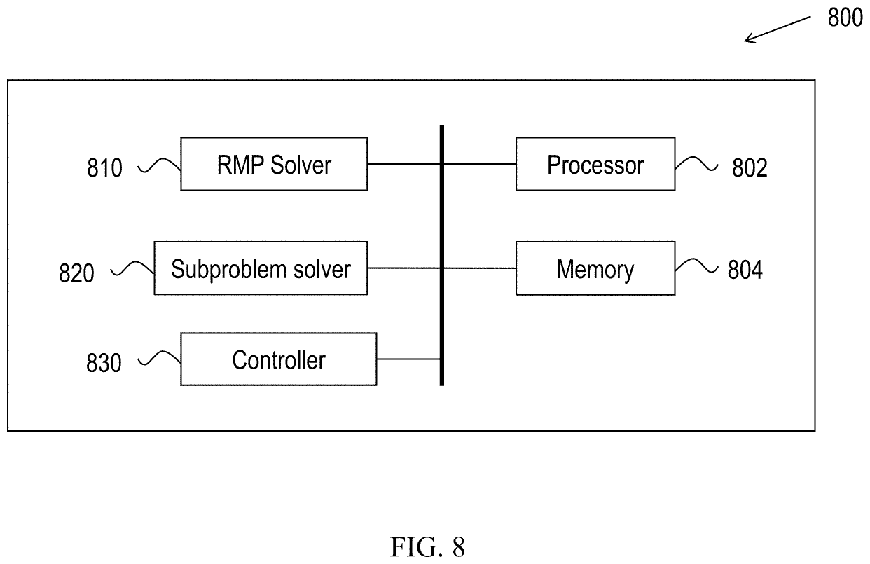

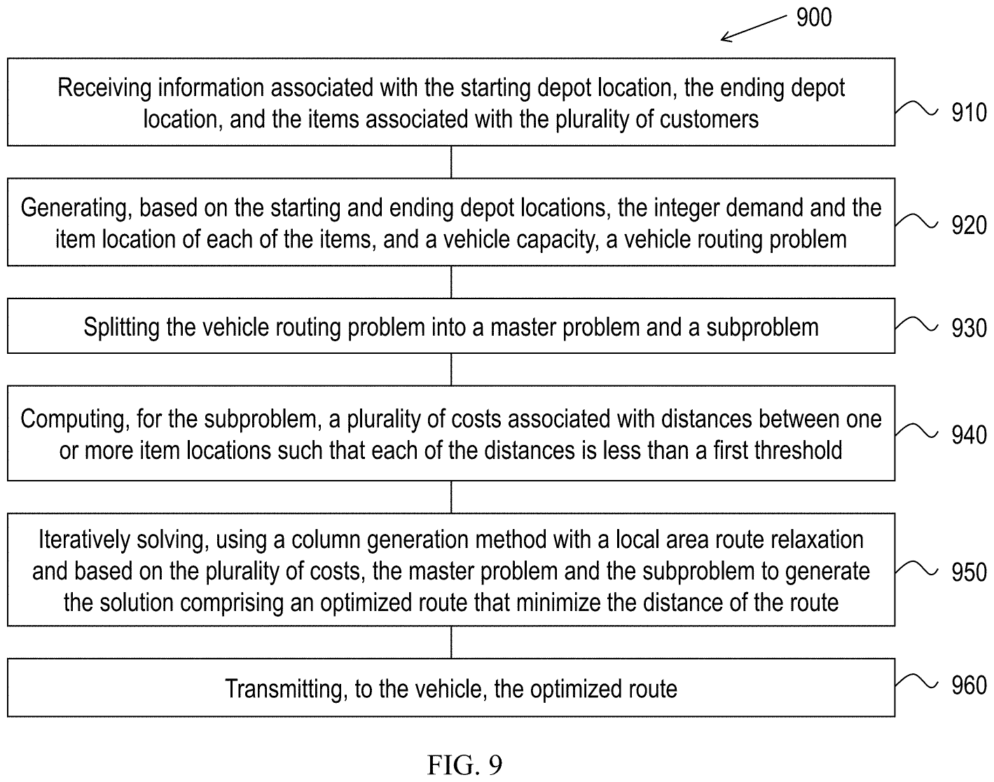

FIG. 8 shows an example of a hardware platform 800 that can be used to implement some of the techniques described in the present document. The hardware platform 800 may include a processor 802 that can execute code to implement a method described in this document (e.g., method 900 shown in FIG. 9). The hardware platform 800 may include a memory 804 that may be used to store processor-executable code and/or store data. The hardware platform 800 may further include a controller 830. For example, the controller 830 may implement one or more scheduling or routing algorithms described in this document. The hardware platform may further include a restricted master problem (RMP) solver 810 and a subproblem solver 820, which are configured to implement the CG methods with LA route relaxations, as described in section 3.4. In some embodiments, some portion or all of the RMP solver 810, the subproblem solver 820, and/or the controller 830 may be implemented in the processor 802. In other embodiments, the memory 804 may comprise multiple memories, some of which are exclusively used by the RMP solver, the subproblem solver, and/or the controller.

In some embodiments, the RMP solver 810 and the subproblem solver 820 may be configured to implement one or more of detour-DOI, graph generation (GG), and principled graph management (PGM), as described in section 3.1, 3.2, and 3.3, respectively.

FIG. 9 shows an example of a method 900 for routing a vehicle from a starting depot location to an ending depot location, where the route services a plurality of customers, each of the plurality of customers being associated with an item. The method 900 includes, at operation 910, receiving information associated with the starting depot location, the ending depot location, and the items associated with the plurality of customers

The method 900 includes, at operation 920, generating, based on the starting depot location, the ending depot location, the integer demand and the item location of each of the items, and a capacity of the vehicle, a vehicle routing problem.

The method 900 includes, at operation 930, splitting the vehicle routing problem into a master problem and a subproblem, wherein the master problem and the subproblem comprise constraints associated with the vehicle routing problem.

The method 900 includes, at operation 940, computing, for the subproblem, a plurality of costs associated with distances between one or more item locations such that each of the distances is less than a first threshold.

The method 900 includes, at operation 950, iteratively solving, using a column generation method with a local area route relaxation and based on the plurality of costs, the master problem and the subproblem to generate the solution comprising an optimized route that minimize the distance of the route.

The method 900 includes, at operation 960, transmitting, to the vehicle, the optimized route, which minimizes a distance of the route.

In some embodiments, the column generation method comprises adding a column to the master problem as part of solving the subproblem, wherein the column corresponds to a particular route with a topological ordering of items serviced by a particular vehicle on the particular route.

In some embodiments, the local area route relaxation comprises an ng-route relaxation. In an example, the ng-route relaxation specifies that a first item location is followed by a second item location such that a distance between the first item location and the second item location is greater than a second threshold. In another example, the local area route relaxation specifies that the distance between the first item location and the second item location is greater than a third threshold.

In some embodiments, the third threshold is greater than the second threshold.

In some embodiments, the master problem is a linear programming problem and the subproblem is a pricing problem.

In some embodiments, the pricing problem is an integer linear program (ILP) that is solved using Dijkstra's shortest-path algorithm.

In some embodiments, the processor is part of a cloud computing infrastructure.

In some embodiments, the at least one processor comprises a first processor that is used to solve the master problem and a second processor that is used to solve the subproblem.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A system for vehicular routing, comprising:
at least one memory; and
at least one processor that is coupled to the at least one memory,
wherein the at least one processor is configured to determine a route for a vehicle from a starting depot location to an ending depot location,
wherein the route services a plurality of customers, each of the plurality of customers being associated with an item, and
wherein the at least one processor is further configured to:
receive information associated with the starting depot location, the ending depot location, and the items associated with the plurality of customers, wherein the information for each of the items comprises an item location and an integer demand indicating a size of the item,
generate, based on the starting depot location, the ending depot location, the integer demand and the item location of each of the items, and a capacity of the vehicle, a vehicle routing problem, wherein a solution to the vehicle routing problem minimizes a distance of the route, wherein the route (a) starts at the starting depot location, (b) ends at the ending depot location, (c) visits each item location no more than once, and (d) services a capacity that does not exceed the capacity of the vehicle to carry items,
split the vehicle routing problem into a master problem and a subproblem, wherein the master problem and the subproblem comprise constraints associated with the vehicle routing problem,
compute, for the subproblem, a plurality of costs associated with distances between one or more item locations such that each of the distances is less than a first threshold,
iteratively solve, using a column generation method with a local area route relaxation and based on the plurality of costs, the master problem and the subproblem to generate the solution comprising an optimized route that minimizes the distance of the route, and
transmit, to the vehicle, the optimized route,
wherein the column generation method comprises adding a column to the master problem as part of solving the subproblem, wherein the column corresponds to a particular route with a topological ordering of items serviced by a particular vehicle on the particular route,
wherein the local area route relaxation comprises an ng-route relaxation,
wherein the ng-route relaxation specifies that a first item location is followed by a second item location such that a distance between the first item location and the second item location is greater than a second threshold,
wherein the local area route relaxation specifies that the distance between the first item location and the second item location is greater than a third threshold, and
wherein the first threshold, second threshold and third threshold are positive numbers.

2. The system of claim 1, wherein the third threshold is greater than the second threshold.

3. The system of claim 1, wherein the starting depot location and the ending depot location are collocated.

4. The system of claim 1, wherein the master problem is a linear programming problem and the subproblem is a pricing problem.

5. The system of claim 4, wherein the pricing problem is an integer linear program (ILP) that is solved using Dijkstra's shortest-path algorithm.

6. The system of claim 1, wherein the at least one processor is part of a cloud computing infrastructure.

7. The system of claim 6, wherein the at least one processor comprises a first processor that is used to solve the master problem and a second processor that is used to solve the subproblem.

8. A method for routing a plurality of robots in a warehouse, the plurality of robots being configured to service a plurality of customers, each of the plurality of customers being associated with an item, and the method comprising:
receiving information associated with a depot location and the items associated with the plurality of customers, wherein the information for each of the items comprises an item location and an integer demand indicating a size of the item;
generating, based on the depot location, the integer demand and the item location of each of the items, and a capacity of each of the plurality of robots, a robot routing problem, wherein a solution to the robot routing problem minimizes a distance of the route, wherein the route (a) starts at the depot location, (b) ends at the depot location, (c) visits each item location no more than once, and (d) services a capacity that does not exceed the capacity of the corresponding robot to carry items;
splitting the robot routing problem into a master problem and a subproblem, wherein the master problem and the subproblem comprise constraints associated with the robot routing problem;
computing, for the subproblem, a plurality of costs associated with distances between one or more item locations such that each of the distances is less than a first threshold;
iteratively solving, using a column generation method with a local area route relaxation and based on the plurality of costs, the master problem and the subproblem to generate the solution comprising an optimized route that minimizes the distance of the route; and
transmitting, to each of the plurality of robots, the corresponding optimized route,
wherein the column generation method comprises adding a column to the master problem as part of solving the subproblem, wherein the column corresponds to a particular route with a topological ordering of items serviced by a particular vehicle on the particular route,
wherein the local area route relaxation comprises an ng-route relaxation,
wherein the ng-route relaxation specifies that a first item location is followed by a second item location such that a distance between the first item location and the second item location is greater than a second threshold,
wherein the local area route relaxation specifies that the distance between the first item location and the second item location is greater than a third threshold, and
wherein the first threshold, second threshold and third threshold are positive numbers.

9. The method of claim 8, wherein the third threshold is greater than the second threshold.

10. The method of claim 8, wherein the master problem is a linear programming problem and the subproblem is a pricing problem.

11. The method of claim 10, wherein the pricing problem is an integer linear program (ILP) that is solved using Dijkstra's shortest-path algorithm.

12. A method for routing a plurality of autonomous vehicles from a depot location, comprising:
receiving information associated with the depot location and a plurality of customers, wherein each of the plurality of customers is associated with an item, and wherein the information for each of the items comprises an item location and an integer demand indicating a size of the item;
generating, based on the depot location, the integer demand and the item location of each of the items, and a capacity of each of the plurality of autonomous vehicles, a vehicle routing problem, wherein a solution to the vehicle routing problem minimizes a distance of the route, wherein the route (a) starts at the depot location, (b) ends at the depot location, and (c) visits each item location no more than once, wherein each autonomous vehicle is configured to service a capacity that does not exceed its capacity to carry items;
iteratively solving, using a column generation method with a local area route relaxation, the vehicle routing problem to generate the solution comprising an optimized route that minimizes the distance of the route; and
transmitting, to each of the plurality of autonomous vehicles, the corresponding optimized route,
wherein the vehicle routing problem comprises a master problem and a subproblem, the master problem and the subproblem comprising constraints associated with the vehicle routing problem,
wherein the column generation method comprises adding a column to the master problem as part of solving the subproblem, wherein the column corresponds to a particular route with a topological ordering of items serviced by a particular vehicle on the particular route,
wherein the local area route relaxation comprises an ng-route relaxation,
wherein the ng-route relaxation specifies that a first item location is followed by a second item location such that a distance between the first item location and the second item location is greater than a second threshold,
wherein the local area route relaxation specifies that the distance between the first item location and the second item location is greater than a third threshold, and
wherein the first threshold, second threshold and third threshold are positive numbers.

13. The method of claim 12, wherein the autonomous vehicle is operating in a Society of Automotive Engineers (SAE) Level 4 (L4) automation mode.

14. The method of claim 12, wherein the third threshold is greater than the second threshold.

15. The method of claim 12, wherein the master problem is a linear programming problem and the subproblem is a pricing problem.

16. The method of claim 15, wherein the pricing problem is an integer linear program (ILP) that is solved using Dijkstra's shortest-path algorithm.
